(19) United States
(12) Patent Application Publication
(10) Pub. No.: US 2025/0141520 A1
(43) Pub. Date: May 1, 2025

(54) CHANNEL STATE INFORMATION FEEDBACK METHOD, TERMINAL DEVICE, AND ACCESS NETWORK DEVICE

(71) Applicant: HUAWEI TECHNOLOGIES CO., LTD., Shenzhen (CN)

(72) Inventors: Ting LI, Shanghai (CN); Xiaohan WANG, Shanghai (CN); Huangping JIN, Shanghai (CN)

(21) Appl. No.: 19/008,897

(22) Filed: Jan. 3, 2025

Related U.S. Application Data
(63) Continuation of application No. PCT/CN2023/101221, filed on Jun. 20, 2023.

(30) Foreign Application Priority Data
Jul. 4, 2022 (CN) 202210779750.8

(51) Int. Cl. H04B 7/06; H04W 76/38

(52) U.S. Cl. CPC H04B 7/0626; H04W 76/38

(57) ABSTRACT

This application provides a channel state information (CSI) feedback method, a terminal device, and an access network device. The method includes: The terminal device sends first CSI to the access network device, where the first CSI includes indication information of a first basis of statistical eigen subspace, and a period for sending the first CSI is a first period. The terminal device sends second CSI to the access network device, where the second CSI includes indication information of a first linear combination coefficient, and a period for sending the second CSI is a second period. The terminal device updates a second basis to the first basis based on trigger information. The terminal device sends third CSI to the access network device, where the third CSI includes indication information of a second linear combination coefficient, and the third CSI is generated based on the updated second basis.

### CROSS-REFERENCE TO RELATED APPLICATIONS

International Application No. This application is a continuation of PCT/CN2023/101221, filed on Jun. 20, 2023, which claims priority to Chinese Patent Application No. 202210779750.8, filed on Jul. 4, 2022. The disclosures of the aforementioned applications are hereby incorporated by reference in their entireties.

### TECHNICAL FIELD

This application relates to the communication field, and more specifically, to a channel state information feedback method, a terminal device, and an access network device.

### BACKGROUND

A 5G communication system has higher requirements on aspects such as a system capacity and spectral efficiency. In the 5G communication system, application of a massive multiple-antenna technology plays a critical role in improving the spectral efficiency of the system. When a multiple-input multiple-output (MIMO) technology is used, an access network device needs to precode data before sending the data to UE. In a frequency division duplex (FDD) system, because a gap between uplink and downlink frequency bands is greater than bandwidth, there is no complete reciprocity between uplink and downlink channels. The access network device requires a terminal device to feed back channel state information (CSI) of a downlink channel to the access network device, to determine a precoding matrix. Therefore, how to accurately feed back the CSI is an important factor that affects system performance.

### SUMMARY

This application provides a channel state information feedback method, a terminal device, and an access network device, to accurately feed back CSI information, improve accuracy of a precoding matrix, and improve system performance.

According to a first aspect, a channel state information feedback method is provided, including: A terminal device sends first channel state information (CSI) to an access network device, where the first CSI includes indication information of a first basis of statistical eigen subspace, and a period for sending the first CSI by the terminal device is a first period. Before the terminal device updates a second basis to the first basis, the terminal device sends second CSI to the access network device, where the second CSI includes indication information of a first linear combination coefficient, a period for sending the second CSI by the terminal device is a second period, the first period is greater than the second period, and the first linear combination coefficient is a combination coefficient corresponding to the second basis. The second CSI is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The terminal device updates the second basis to the first basis based on trigger information. After the terminal device updates the second basis to the first basis, the terminal device sends third CSI to the access network device, where the third CSI includes indication information of a second linear combination coefficient, the third CSI is generated by the terminal device based on the updated second basis, and a period for sending the third CSI by the terminal device is the second period.

The terminal device updates a statistical eigen subspace basis based on the trigger information, and updates the second basis to the first basis. Based on the trigger information, it may be ensured that the access network device and the terminal device synchronously update the statistical eigen subspace basis. After the terminal device updates the basis, the terminal device sends, to the access network device, the third CSI generated based on the updated second basis. A basis used by the access network device is the updated second basis. Therefore, the second linear combination coefficient obtained by the access network device based on the received indication information that is of the second linear combination coefficient and that is reported in the second period can match the first basis that is of the statistical eigen subspace and that is used to restore a precoding matrix. This improves accuracy of the precoding matrix and improves system performance.

With reference to the first aspect, in a possible implementation of the first aspect, when the trigger information is timing information, that the terminal device updates the second basis to the first basis based on trigger information includes: When the timing information reaches a specified time, the terminal device updates the second basis to the first basis.

The terminal device updates the second basis to the first basis based on the timing information, to ensure that the access network device (the access network device also updates the second basis to the first basis based on the timing information) and the terminal device synchronously update the statistical eigen subspace basis. Therefore, signaling overheads can be further reduced by accurately feeding back CSI information.

With reference to the first aspect, in a possible implementation of the first aspect, the timing information is obtained by the terminal device from the access network device by using configuration information, or the timing information is predefined.

With reference to the first aspect, in a possible implementation of the first aspect, the terminal device receives update indication information sent by the access network device, where the update indication information indicates the terminal device to update the second basis of the statistical eigen subspace to the first basis. That the terminal device updates the second basis to the first basis based on trigger information includes: The terminal device updates the second basis to the first basis based on the update indication information.

After receiving the indication information, the terminal device updates the second basis to the first basis, to ensure that the access network device (the access network device updates the second basis to the first basis after sending the indication information) and the terminal device synchronously update the statistical eigen subspace basis. Therefore, CSI information is accurately fed back.

With reference to the first aspect, in a possible implementation of the first aspect, before that the terminal device updates the second basis to the first basis based on trigger information, the method further includes: The terminal device receives retransmission signaling sent by the access network device, where the retransmission signaling indicates the terminal device to retransmit the first CSI. The terminal device retransmits the first CSI to the access network device based on the retransmission signaling.

When the access network device fails to obtain the indication information of the first basis, the access network device sends the retransmission signaling to the terminal device to indicate the terminal device to retransmit the first CSI, so that the indication information of the first basis is re-obtained. Then, the terminal device updates the second basis of the statistical eigen subspace to the first basis based on the timing information. Therefore, the second linear combination coefficient obtained by the access network device based on the received indication information that is of the second linear combination coefficient and that is reported in the second period can match the first basis that is of the statistical eigen subspace and that is used to restore the precoding matrix. This improves the accuracy of the precoding matrix and improves the system performance.

With reference to the first aspect, in a possible implementation of the first aspect, a duration of the timing information is information locally configured on the terminal device, is predefined in a protocol, and is known to both the access network device and the terminal device. Alternatively, the access network device sends a duration of the first period, a duration of the second period, and a duration of the timing information to the terminal device by using the configuration information. Alternatively, the duration of the timing information may be determined by the terminal device and then reported to the access network device.

With reference to the first aspect, in a possible implementation of the first aspect, at least one of the update indication information, the configuration information, or the retransmission signaling is included in radio resource control (RRC) signaling, media access control-control element (MAC-CE) signaling, or downlink control information (DCI).

According to a second aspect, a channel state information feedback method is provided, including: An access network device receives and parses first channel state information (CSI) sent by a terminal device, where the first CSI includes indication information of a first basis of statistical eigen subspace, and a period for receiving the first CSI by the access network device is a first period. Before the access network device updates a second basis to the first basis, the access network device receives and parses second CSI sent by the terminal device, where the second CSI includes indication information of a first linear combination coefficient, a period for receiving the second CSI by the access network device is a second period, the first period is greater than the second period, and the first linear combination coefficient is a combination coefficient corresponding to the second basis. A statistical eigen subspace basis currently used by the access network device is the second basis of the statistical eigen subspace, the second CSI is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The access network device updates the second basis to the first basis based on timing information. After the access network device updates the second basis to the first basis, the access network device receives and parses third CSI sent by the terminal device, where the third CSI includes indication information of a second linear combination coefficient, the third CSI is generated by the terminal device based on the updated second basis, and a period for sending the third CSI by the terminal device is the second period. The access network device determines a precoding matrix based on the first basis and the second linear combination coefficient.

The access network device updates the statistical eigen subspace basis based on the timing information, and updates the second basis to the first basis. Based on the timing information, it may be ensured that the access network device and the terminal device synchronously update the statistical eigen subspace basis. After the access network device updates the basis, the access network device receives the third CSI, where the third CSI includes the indication information of the second linear combination coefficient, the third CSI is generated by the terminal device based on the updated second basis, and a basis used by the access network device is the updated second basis. Therefore, the second linear combination coefficient obtained by the access network device based on the received indication information that is of the second linear combination coefficient and that is reported in the second period can match the first basis that is of the statistical eigen subspace and that is used to restore the precoding matrix. This improves accuracy of the precoding matrix and improves system performance.

With reference to the second aspect, in a possible implementation of the second aspect, the timing information is determined by the access network device or predefined.

With reference to the second aspect, in a possible implementation of the second aspect, when the timing information is determined by the access network device, the method further includes: The access network device sends configuration information to the terminal device.

With reference to the second aspect, in a possible implementation of the second aspect, before that the access network device updates the second basis to the first basis based on timing information, the method further includes: When the access network device fails to obtain the first basis, the access network device sends retransmission signaling to the terminal device, where the retransmission signaling indicates the terminal device to retransmit the first CSI.

The access network device receives the first CSI retransmitted by the terminal device.

With reference to the second aspect, in a possible implementation of the second aspect, that the access network device fails to obtain the first basis includes: The access network device fails to receive the first CSI; or the access network device fails to parse the first CSI.

With reference to the second aspect, in a possible implementation of the second aspect, a duration of the timing information is information locally configured on the terminal device, is predefined in a protocol, and is known to both the access network device and the terminal device. Alternatively, the access network device sends a duration of the first period, a duration of the second period, and the duration of the timing information to the terminal device by using the configuration information. Alternatively, the duration of the timing information may be determined by the terminal device and then reported to the access network device.

With reference to the second aspect, in a possible implementation of the second aspect, at least one of the configuration information or the retransmission signaling is included in radio resource control (RRC) signaling, media access control-control element (MAC-CE) signaling, or downlink control information (DCI).

According to a third aspect, a channel state information feedback method is provided, including: An access network device receives and parses first channel state information (CSI) sent by a terminal device, where the first CSI includes indication information of a first basis of statistical eigen subspace, and a period for receiving the first CSI by the access network device is a first period. Before the access network device updates a second basis to the first basis, the access network device receives and parses second CSI sent by the terminal device, where the second CSI includes indication information of a first linear combination coefficient, a period for receiving the second CSI by the access network device is a second period, the first period is greater than the second period, and the first linear combination coefficient is a combination coefficient corresponding to the second basis. A statistical eigen subspace basis currently used by the access network device is the second basis, the second CSI is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The access network device updates the second basis to the first basis. The access network device sends update indication information to the terminal device, where the update indication information indicates the terminal device to update the second basis to the first basis. After the access network device updates the second basis to the first basis, the access network device receives and parses third CSI sent by the terminal device, where the third CSI includes indication information of a second linear combination coefficient, the third CSI is generated by the terminal device based on the updated second basis, and a period for sending the third CSI by the terminal device is the second period. The access network device determines a precoding matrix based on the first basis and the second linear combination coefficient.

The access network device determines to update a statistical eigen subspace basis, and the access network device sends indication information to the terminal device to indicate the terminal device to update the statistical eigen subspace basis, so that the access network device and the terminal device can synchronously update the statistical eigen subspace basis. Therefore, the second linear combination coefficient obtained by the access network device based on the received indication information that is of the second linear combination coefficient and that is reported in the second period can match the first basis that is of the statistical eigen subspace and that is used to restore the precoding matrix. This improves accuracy of the precoding matrix and improves system performance.

With reference to the third aspect, in a possible implementation of the third aspect, before that the access network device updates the second basis to the first basis, the method further includes: When the access network device fails to obtain the first basis, the access network device sends retransmission signaling to the terminal device, where the retransmission signaling indicates the terminal device to retransmit the first CSI. The access network device receives the first CSI retransmitted by the terminal device.

With reference to the third aspect, in a possible implementation of the third aspect, that the access network device fails to obtain the first basis includes: The access network device fails to receive the first CSI; or the access network device fails to parse the first CSI.

With reference to the third aspect, in a possible implementation of the third aspect, the access network device sends a duration of the first period and a duration of the second period to the terminal device by using configuration information. Alternatively, a duration of timing information may be determined by the terminal device and then reported to the access network device.

With reference to the third aspect, in a possible implementation of the third aspect, at least one of the update indication information or the retransmission signaling is sent by using radio resource control (RRC) signaling, media access control-control element (MAC-CE) signaling, or downlink control information (DCI).

According to a fourth aspect, a terminal device is provided, including: a transceiver, configured to send first channel state information (CSI) to an access network device, where the first CSI includes indication information of a first basis of statistical eigen subspace, and a period for sending the first CSI by the terminal device is a first period, where the transceiver is further configured to: before the terminal device updates a second basis to the first basis, send second CSI to the access network device, where the second CSI includes indication information of a first linear combination coefficient, a period for sending the second CSI by the terminal device is a second period, the first period is greater than the second period, and the first linear combination coefficient is a combination coefficient corresponding to the second basis, where the second CSI is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain; and a processor, configured to update the second basis to the first basis based on trigger information, where the transceiver is further configured to: after the terminal device updates the second basis to the first basis, send third CSI to the access network device, where the third CSI includes indication information of a second linear combination coefficient, the third CSI is generated by the terminal device based on the updated second basis, and a period for sending the third CSI by the terminal device is the second period.

With reference to the fourth aspect, in a possible implementation of the fourth aspect, the processor is further configured to: when timing information reaches a specified time, update the second basis to the first basis.

With reference to the fourth aspect, in a possible implementation of the fourth aspect, the timing information is obtained by the transceiver from the access network device by using configuration information, or the timing information is predefined.

With reference to the fourth aspect, in a possible implementation of the fourth aspect, the transceiver is configured to receive update indication information sent by the access network device, where the update indication information indicates the terminal device to update the second basis of the statistical eigen subspace to the first basis. The processor is specifically configured to update the second basis to the first basis based on the update indication information.

With reference to the fourth aspect, in a possible implementation of the fourth aspect, the transceiver is further configured to: receive retransmission signaling sent by the access network device, where the retransmission signaling indicates the terminal device to retransmit the first CSI; and retransmit the first CSI to the access network device based on the retransmission signaling.

With reference to the fourth aspect, in a possible implementation of the fourth aspect, a duration of the timing information is information locally configured on the terminal device, is predefined in a protocol, and is known to both the access network device and the terminal device. Alternatively, the access network device sends a duration of the first period, a duration of the second period, and the duration of the timing information to the terminal device by using the configuration information. Alternatively, the duration of the timing information may be determined by the terminal device and then reported to the access network device.

With reference to the fourth aspect, in a possible implementation of the fourth aspect, at least one of the update indication information, the configuration information, or the retransmission signaling is included in radio resource control (RRC) signaling, media access control-control element (MAC-CE) signaling, or downlink control information (DCI).

According to a fifth aspect, an access network device is provided, including: a transceiver, configured to receive first channel state information (CSI) sent by a terminal device, where the first CSI includes indication information of a first basis of statistical eigen subspace, and a period for receiving the first CSI by the access network device is a first period; and a processor, configured to parse the first CSI. The transceiver is configured to: before the access network device updates a second basis to the first basis, receive second CSI sent by the terminal device, where the second CSI includes indication information of a first linear combination coefficient, a period for receiving the second CSI by the access network device is a second period, the first period is greater than the second period, and the first linear combination coefficient is a combination coefficient corresponding to the first basis. A statistical eigen subspace basis currently used by the processor is the second basis of the statistical eigen subspace, the second CSI is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The processor is configured to parse the second CSI. The processor is configured to update the second basis to the first basis based on timing information. After the access network device updates the second basis to the first basis, the transceiver receives third CSI sent by the terminal device, where the third CSI includes indication information of a second linear combination coefficient, the third CSI is generated by the terminal device based on the updated second basis, and a period for sending the third CSI by the terminal device is the second period. The processor is configured to parse the third CSI. The processor is configured to determine a precoding matrix based on the first basis and the second linear combination coefficient.

With reference to the fifth aspect, in a possible implementation of the fifth aspect, the timing information is determined by the access network device or predefined.

With reference to the fifth aspect, in a possible implementation of the fifth aspect, when the timing information is determined by the access network device, the transceiver is further configured to send configuration information to the terminal device.

With reference to the fifth aspect, in a possible implementation of the fifth aspect, the transceiver is further configured to: when the first basis is failed to be obtained, send retransmission signaling to the terminal device, where the retransmission signaling indicates the terminal device to retransmit the first CSI; and receive the first CSI retransmitted by the terminal device.

With reference to the fifth aspect, in a possible implementation of the fifth aspect, that the access network device fails to obtain the first basis includes: The transceiver fails to receive the first CSI; or the processor fails to parse the first CSI.

With reference to the fifth aspect, in a possible implementation of the fifth aspect, a duration of the timing information is information locally configured on the terminal device, is predefined in a protocol, and is known to both the access network device and the terminal device. Alternatively, the access network device sends a duration of the first period, a duration of the second period, and the duration of the timing information to the terminal device by using the configuration information. Alternatively, the duration of the timing information may be determined by the terminal device and then reported to the access network device.

With reference to the fifth aspect, in a possible implementation of the fifth aspect, at least one of the configuration information or the retransmission signaling is included in radio resource control (RRC) signaling, media access control-control element (MAC-CE) signaling, or downlink control information (DCI).

According to a sixth aspect, an access network device is provided, including: a transceiver, configured to receive first channel state information (CSI) sent by a terminal device, where the first CSI includes indication information of a first basis of statistical eigen subspace, and a period for receiving the first CSI by the access network device is a first period; and a processor, configured to parse the first CSI. The transceiver is configured to: before the access network device updates a second basis to the first basis, receive second CSI sent by the terminal device, where the second CSI includes indication information of a first linear combination coefficient, a period for receiving the second CSI by the access network device is a second period, the first period is greater than the second period, and the first linear combination coefficient is a combination coefficient corresponding to the second basis. A statistical eigen subspace basis currently used by the processor is the second basis of the statistical eigen subspace, the second CSI is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The processor is configured to parse the second CSI. The access network device updates the second basis to the first basis. The transceiver sends update indication information to the terminal device, where the update indication information indicates the terminal device to update the second basis to the first basis. After the access network device updates the second basis to the first basis, the transceiver receives third CSI sent by the terminal device, where the third CSI includes indication information of a second linear combination coefficient, the third CSI is generated by the terminal device based on the updated second basis, and a period for sending the third CSI by the terminal device is the second period. The processor is configured to parse the third CSI. The processor is configured to determine a precoding matrix based on the first basis and the second linear combination coefficient.

With reference to the sixth aspect, in a possible implementation of the sixth aspect, the transceiver is further configured to: when the first basis is failed to be obtained, send retransmission signaling to the terminal device, where the retransmission signaling indicates the terminal device to retransmit the first CSI; and receive the first CSI retransmitted by the terminal device.

With reference to the sixth aspect, in a possible implementation of the sixth aspect, that the first basis is failed to be obtained includes: The transceiver fails to receive the first CSI; or the processor fails to parse the first CSI.

With reference to the sixth aspect, in a possible implementation of the sixth aspect, the access network device sends a duration of the first period and a duration of the second period to the terminal device by using configuration information.

With reference to the sixth aspect, in a possible implementation of the sixth aspect, at least one of the update indication information or the retransmission signaling is sent by using radio resource control (RRC) signaling, media access control-control element (MAC-CE) signaling, or downlink control information (DCI).

According to a seventh aspect, a computer program product is provided. The computer program product includes instructions. When the instructions are run on a computer, the computer is enabled to perform the method in any one of the first aspect or the possible implementations of the first aspect, perform the method in any one of the second aspect or the possible implementations of the second aspect, or perform the method in any one of the third aspect or the possible implementations of the third aspect.

According to an eighth aspect, a computer-readable storage medium is provided. The computer-readable storage medium stores a computer program. When the computer program is executed, the computer program is used to perform the method in any one of the first aspect or the possible implementations of the first aspect, perform the method in any one of the second aspect or the possible implementations of the second aspect, or perform the method in any one of the third aspect or the possible implementations of the third aspect.

According to a ninth aspect, a chip system is provided. The chip system includes a processor, and is used by a communication apparatus to implement a function in the foregoing aspects, such as generating, receiving, sending, or processing data and/or information related to the foregoing methods. In a possible design, the chip system further includes a memory. The memory is configured to store program instructions and data that are necessary for the communication apparatus. The chip system may include a chip, or may include a chip and another discrete component.

According to a tenth aspect, a communication system is provided. The communication system includes a terminal device that has a function of implementing the method and the possible designs in the first aspect and an access network device that has a function of implementing the method and the possible designs in the second aspect. Alternatively, the communication system includes a terminal device that has a function of implementing the method and the possible designs in the first aspect and an access network device that has a function of implementing the method and the possible designs in the third aspect.

### BRIEF DESCRIPTION OF DRAWINGS

FIG. 1 is a diagram of an architecture of an example communication system according to an embodiment of this application;

FIG. 2 is a diagram of an architecture of another example communication system according to an embodiment of this application;

FIG. 3 is a schematic flowchart of an example method for feeding back CSI of a downlink channel by user equipment to an access network device;

FIG. 4 is a schematic flowchart of example air interface interaction of CSI when a statistical eigen subspace codebook is used;

FIG. 5 is a schematic flowchart of an example channel state information feedback method according to an embodiment of this application;

FIG. 6 is a schematic flowchart of example air interface interaction between an access network device and a terminal device according to an embodiment of this application;

FIG. 7 is a schematic flowchart of example air interface interaction between an access network device and a terminal device according to an embodiment of this application;

FIG. 8 is a schematic flowchart of an example precoding matrix determining method according to an embodiment of this application;

FIG. 9 is a schematic flowchart of example air interface interaction between an access network device and a terminal device according to an embodiment of this application;

FIG. 10 is a schematic flowchart of example air interface interaction between an access network device and a terminal device according to an embodiment of this application;

FIG. 11 is a diagram of example module interaction between a terminal device and an access network device according to an embodiment of this application;

FIG. 12 is a block diagram of an example communication apparatus according to an embodiment of this application;

FIG. 13 is a block diagram of an example communication apparatus according to an embodiment of this application;

FIG. 14 is a diagram of a structure of an example terminal device according to an embodiment of this application; and

FIG. 15 is a diagram of a structure of an example access network device according to an embodiment of this application.

### DESCRIPTION OF EMBODIMENTS

The following describes technical solutions in the present disclosure with reference to accompanying drawings.

The technical solutions in embodiments of the present disclosure may be applied to various communication systems, for example, a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, and a 5th generation (5G) system or a new radio (NR) system. In addition, the technical solutions are alternatively applicable to a subsequent evolved system, for example, a 6th generation (6G) communication system or an even more advanced 7th generation (7G) communication system.

An access network device in embodiments of this application may be a device that communicates with a terminal device, may be a base station, an access point, or a network device, or may be a device that communicates with a wireless terminal over an air interface in an access network by using one or more sectors. The network device may be configured to mutually convert a received over-the-air frame and an IP packet and serve as a router between the wireless terminal and a rest portion of the access network, where the rest portion of the access network may include an internet protocol (IP) network. The network device may further coordinate attribute management of the air interface. For example, the access network device may be a base station (BTS) in the GSM or the CDMA, may be a NodeB (NB) in the WCDMA, may be an evolved NodeB (eNB or eNodeB) in the LTE system, or may be a radio controller in a cloud radio access network (CRAN) scenario. Alternatively, the access device may be a relay station, an access point, a vehicle-mounted device, a wearable device, an access device in a 5G network, a network device in a future evolved PLMN network, or the like, may be an access point (AP) in a WLAN, or may be a gNB in the new radio (NR) system. This is not limited in embodiments of this application. It should be noted that, in the 5G system, there may be one or more transmission reception points (TRPs) on one base station. All TRPs belong to a same cell. A measurement reporting method described in embodiments of this application may be used for each TRP and the terminal. In another scenario, the network device may be further divided into a control unit (CU) and a distributed unit (DU). There may be a plurality of DUs under one CU. The measurement reporting method described in embodiments of this application may be used for each DU and the terminal. A difference between a CU-DU separation scenario and a multi-TRP scenario lies in that a TRP only serves as a radio frequency unit or an antenna device, but a DU may implement a protocol stack function, for example, the DU may implement a physical layer function.

In addition, in embodiments of this application, the access network device is a device in an access network (RAN), in other words, a RAN node that connects the terminal device to a wireless network. For example, by way of example and not limitation, the access network device may be a gNB, a transmission reception point (TRP), an evolved NodeB (eNB), a radio network controller (RNC), a NodeB (NB), a base station controller (BSC), a base transceiver station (BTS), a home base station (for example, a home evolved NodeB, or a home NodeB, HNB), a baseband unit (BBU), a wireless fidelity (Wi-Fi) access point (AP), or the like.

The access network device provides a service for a cell. The terminal device communicates with the access network device by using a transmission resource (for example, a frequency domain resource, in other words, a spectrum resource) used for the cell. The cell may be a cell corresponding to the access network device (for example, a base station), and the cell may belong to a macro base station, or may belong to a base station corresponding to a small cell. The small cell herein may include: a metro cell, a micro cell, a pico cell, a femto cell, and the like. These small cells have features of small coverage and low transmit power, and are suitable for providing a high-rate data transmission service.

The terminal device in embodiments of this application may also be referred to as user equipment (UE), a mobile station (MS), a mobile terminal (MT), an access terminal, a subscriber unit, a subscriber station, a mobile station, a remote station, a remote terminal, a mobile device, a user terminal, a terminal, a wireless communication device, a user agent, a user apparatus, or the like.

The terminal device may be a device that provides voice/data connectivity for a user, for example, a handheld device or a vehicle-mounted device that has a wireless connection function. Currently, examples of some terminals are as follows: a mobile phone, a tablet computer, a notebook computer, a handheld computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in the 5G network, a terminal device in a future evolved public land mobile network (PLMN), and the like. This is not limited in embodiments of this application.

By way of example and not limitation, in embodiments of this application, the wearable device may also be referred to as a wearable intelligent device, and is a general name of a wearable device developed by intelligently designing daily wear through a wearable technology, such as glasses, gloves, watches, clothing, and shoes. The wearable device is a portable device that can be directly worn on the body or integrated into clothes or an accessory of the user. The wearable device is not only a hardware device, but also implements a powerful function through software support, data exchange, and cloud interaction. In a broad sense, intelligent wearable devices include full-featured and large-size devices that can implement complete or partial functions without depending on smartphones, for example, smart watches or smart glasses, and devices that focus on only one type of application function and need to be work with other devices such as smartphones, such as various smart bands or smart jewelry for monitoring physical signs.

In addition, in embodiments of this application, the terminal device may alternatively be a terminal device in an internet of things (IoT) system. The IoT is an important part of future development of information technologies. A main technical feature of the IoT is to connect things to a network by using a communication technology to implement an intelligent network for interconnection between a person and a machine or between things.

If various terminal devices described above are located in a vehicle (for example, placed in the vehicle or installed in the vehicle), the terminal devices may be all considered as vehicle-mounted terminal devices. For example, the vehicle-mounted terminal device is also referred to as an on-board unit (OBU).

In embodiments of this application, the terminal device may further include a relay. Alternatively, it is understood that any device that can perform data communication with a base station may be considered as the terminal device.

FIG. 1 is a diagram of a communication system 100 according to this application. In FIG. 1, an access network device 110, a terminal device 120, a terminal device 130, a terminal device 140, a terminal device 150, a terminal device 160, and a terminal device 170 are included. For example, the access network device 110 works in an evolved universal mobile telecommunications system terrestrial radio access (E-UTRA) system, works in an NR system, or works in a next generation communication system or another communication system. The access network device 110 may communicate with the terminal device 120 to the terminal device 170 through Uu interfaces, the access network device 110 and the terminal device 120 to the terminal device 170 form a communication system. In the communication system, the terminal device 120 to the terminal device 170 may send uplink data to the access network device 110, the access network device 110 needs to receive the uplink data sent by the terminal device 120 to the terminal device 170, and the access network device 110 may send downlink data to the terminal device 120 to the terminal device 170. In addition, the terminal device 150 to the terminal device 170 may also form a communication system. In the communication system, the access network device may send downlink information to the terminal device 150, and the terminal device 150 may also send downlink information to terminal devices 160 and 170.

In this application, one access network device may serve a plurality of terminal devices. In FIG. 1, only some of the terminal devices are used as examples.

In FIG. 1, the access network device is, for example, a base station. The access network device corresponds to different devices in different systems. For example, the access network device may correspond to an eNB in a 4G system, and corresponds to an access network device in 5G in a 5G system, for example, a gNB. Technical solutions provided in embodiments of this application may also be applied to a future mobile communication system. Therefore, the access network device in FIG. 1 may alternatively correspond to an access network device in the future mobile communication system. In FIG. 1, an example in which the access network device is the base station is used. Actually, with reference to the foregoing descriptions, the access network device may alternatively be a device such as an RSU.

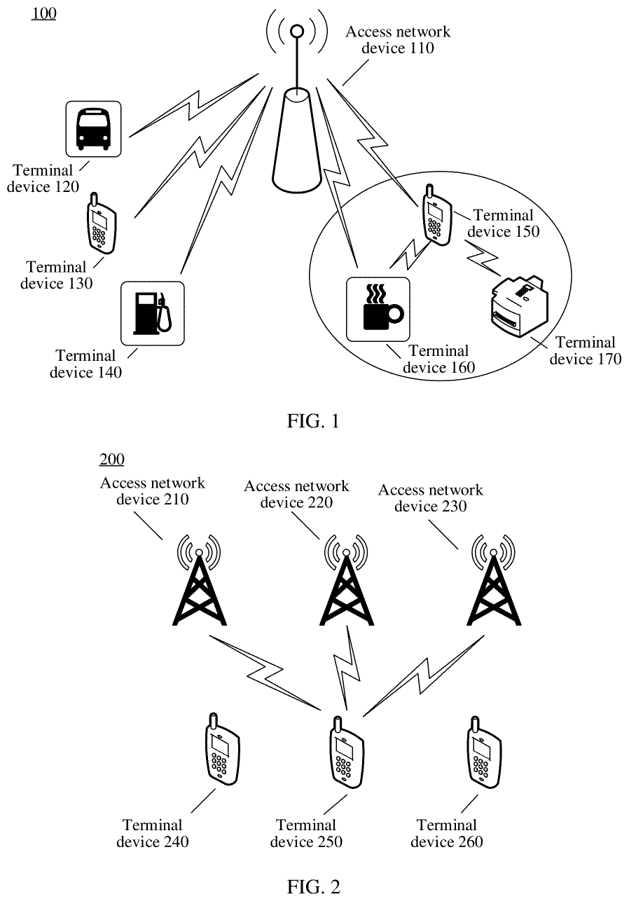

FIG. 2 is a diagram of an architecture of another communication system 200 according to this application. As shown in FIG. 2, a plurality of access network devices (an access network device 210, an access network device 220, and an access network device 230) and a plurality of terminal devices (a terminal device 240, a terminal device 250, and a terminal device 260) form a communication system, and the plurality of access network devices simultaneously serve one terminal device. For example, the access network device 210, the access network device 220, and the access network device 230 simultaneously serve the terminal device 250.

In FIG. 1 or FIG. 2, the access network device is, for example, a base station. The access network device corresponds to different devices in different systems. For example, the access network device may correspond to an eNB in a 4G system, and corresponds to an access network device in 5G in a 5G system, for example, a gNB. Technical solutions provided in this application may also be applied to a future mobile communication system. Therefore, the access network device in FIG. 1 may alternatively correspond to an access network device in the future mobile communication system. In FIG. 1 or FIG. 2, an example in which the access network device is the base station is used. Actually, with reference to the foregoing descriptions, the access network device may alternatively be a device such as an RSU.

It should be understood that the communication system shown in FIG. 1 or FIG. 2 may further include more network nodes, for example, another terminal device or access network device. The access network devices or the terminal devices included in the communication system shown in FIG. 1 or FIG. 2 may be the foregoing access network devices or terminal devices in various forms.

A 5G communication system has higher requirements on aspects such as a system capacity and spectral efficiency. In the 5G communication system, application of a massive multiple-antenna (Massive MIMO) technology plays a critical role in improving the spectral efficiency of the system. When a MIMO technology is used, the access network device needs to precode data before sending the data to UE. How to perform precoding needs to depend on channel state information (CSI) fed back by the user equipment to the access network device. Therefore, accurate CSI feedback information is an important factor that affects system performance.

In a time division duplex (TDD) system, because an uplink channel and a downlink channel use a same frequency band, reciprocity exists. The access network device may obtain CSI of the downlink channel through the uplink channel by using the channel reciprocity, to further perform the precoding.

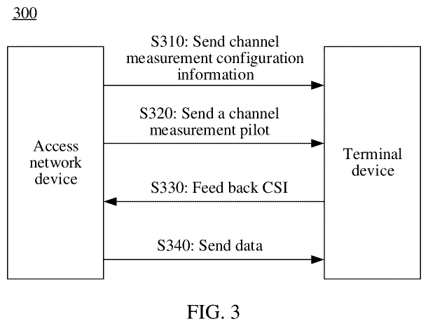

However, in a frequency division duplex (FDD) system, because a gap between uplink and downlink frequency bands is greater than bandwidth, there is no complete reciprocity between uplink and downlink channels. In a conventional FDD system, the user equipment needs to feed back the CSI of the downlink channel to the access network device. A basic procedure is shown in FIG. 3. FIG. 3 is a schematic flowchart of a method 300 for feeding back CSI of a downlink channel by user equipment to an access network device. The method 300 includes S310 to S340.
S310: The access network device sends channel measurement configuration information to a terminal device, where the channel measurement configuration information is used to configure time and a behavior of performing channel measurement by the terminal device.
S320: The access network device sends a reference signal to the terminal device for the channel measurement.
S330: The terminal device performs the measurement based on the reference signal sent by the access network device, performs calculation based on a measurement result to obtain a final CSI feedback amount, and the terminal device feeds back CSI to the access network device.
S340: The access network device sends data based on the CSI fed back by the terminal device.

The CSI may include parameters such as a precoding matrix indicator (PMI), a channel rank indicator (RI), and a channel state indicator (CQI). For example, the access network device may determine, based on a PMI fed back by the terminal device, the precoding matrix for performing transmission of data to the terminal device; the access network device may determine, based on an RI fed back by the terminal device, a quantity of streams for performing transmission of the data to the terminal device; and the access network device may determine, based on a CQI fed back by the terminal device, a modulation order and a channel coding rate for performing transmission of the data to the terminal device.

The PMI is determined and reported based on one set of codebooks, and indicates the precoding matrix. A network device restores the precoding matrix based on the PMI and the codebooks. The precoding matrix may be a precoding matrix determined by the network device based on a channel matrix of each frequency domain unit. For example, the precoding matrix may be obtained by performing singular value decomposition (SVD) on a channel matrix or a covariance matrix of a channel matrix, or may be obtained by performing eigenvalue decomposition (EVD) on a covariance matrix of a channel matrix. The precoding matrix includes channel information of a transmit end of the network device. Design of an FDD CSI codebook is a basic and important problem in a 5G communication system.

In a 3rd generation partnership project (3GPP) R15 Type II codebook, a space domain (angle domain) compression idea is used, and sparsity of a channel in angle domain is used. To be specific, a multipath signal has strong energy in several angle directions and weak energy in other directions. In this case, a space domain discrete fourier transform (DFT) basis vector indicates an angle direction with strong energy, and the precoding matrix is represented by a linear combination of several space domain DFT basis vectors. In a 3GPP R16 Type II codebook, a dual-domain compression idea is proposed. Frequency domain (delay domain) compression is added based on the R15 codebook by using frequency domain correlations between amplitudes and phase coefficients of different subbands. Channel information is separately compressed and fed back in space domain and frequency domain. The precoding matrix is approximately represented by using a weighted sum of a space-frequency component matrix. A space-frequency component matrix is constructed by using one or more space domain basis vectors compressed by space domain and one or more frequency domain basis vectors compressed by frequency domain.

In comparison with the R15 codebook, in the R16 codebook, sparsity of a channel in delay domain is further used. To be specific, energy of a multipath signal is strong on several delay components, energy of the multipath signal is weak on other delay components, and corresponding frequency domain compression is completed. However, the foregoing dual-domain compression codebook only respectively uses the sparsity of the channel in angle domain (space domain) and the sparsity of the channel in delay domain (frequency domain). The one or more selected space domain basis vectors, the one or more selected frequency domain basis vectors, and a weighting coefficient corresponding to the space-frequency component matrix constructed based on the one or more space domain basis vectors and the one or more frequency domain basis vectors need to be reported, and overheads are still high. In addition, it is specified in the protocol that both the space domain basis vector and the frequency domain basis vector are DFT vectors, and resolutions in angle domain and delay domain are limited. Therefore, separate reporting of the space domain basis vector and the frequency domain basis vector limits sparsity of a weighting coefficient matrix. This leads to low system performance.

To fully use the sparsity of the channel in space domain and the sparsity of the channel in frequency domain, and further reduce PMI feedback overheads, feedback may be performed in a manner of statistical eigen subspace codebook. The codebook indicates a downlink channel or a precoding matrix by using a statistical eigen subspace basis in a long period and a corresponding linear combination coefficient.

The codebook may be similar to the R16 Type II codebook, and a bilinear combination of a set of statistical eigen subspace bases in space domain and a set of statistical eigen subspace bases in frequency domain represents the downlink channel or the precoding matrix. Further, in the codebook, space domain and frequency domain may alternatively be joint, and a linear combination of a set of statistical eigen subspace bases that are joint in space domain and frequency domain represents the downlink channel or the precoding matrix. The statistical eigen subspace basis is an eigenvector or an eigenvector group that may indicate a statistical change rule of a channel in space domain, frequency domain, or joint space-frequency domain, and is usually obtained by performing eigenvalue decomposition on a statistical covariance matrix of the channel. Joint space-frequency domain is a joint domain of space domain and frequency domain. Generally, a signal is propagated through a plurality of paths, leaves a transmit end at different angles, and arrives at a receive end at different angles after different delays. Space domain mainly describes an angle direction feature of a channel, and frequency domain mainly describes a delay distribution feature of a channel. Both are considered from a single dimension. For joint space-frequency domain, a combination of space domain and frequency domain is considered, angle direction and delay distribution features of a multipath are mainly described, and an angle direction and a delay distribution are in one-to-one correspondence. A statistical eigen subspace basis indicating a statistical change rule of a channel in space domain is referred to as a space domain basis for short, a statistical eigen subspace basis indicating a statistical change rule of a channel in frequency domain is referred to as a frequency domain basis for short, and a statistical eigen subspace basis indicating a statistical change rule of a channel in joint space-frequency domain is referred to as a space-frequency joint basis for short.

Because the eigen subspace basis describes a statistical feature of a channel in a domain (for example, space domain, frequency domain, or joint space-frequency domain) in which the channel is located, and changes slowly, for such a type of codebook, the terminal device may feed back the statistical eigen subspace basis in a long period (namely, a first period). Because a linear combination coefficient describes a variable that changes fast, for example, a strength or a phase of a path on a channel, the terminal device may feed back, in a short period (namely, a second period), the linear combination coefficient corresponding to the basis. It should be understood that the long period and the short period are relative concepts. The duration of the first period is greater than the duration of the second period. For example, the duration of the first period is a plurality of integer multiples of the duration of the second period. The access network device restores the eigen subspace basis based on a CSI report amount reported by the terminal device in the first period, and restores a precoding matrix of the terminal device in each second period based on a linear combination coefficient reported by the terminal device in the second period. For such a CSI report codebook with the long period and the short period, a basis in the long period and a linear combination coefficient in the short period that are used by the access network device during restoration need to match. How to align ideas of the terminal device and the access network device about whether to update an eigen subspace basis in the long period is extremely important. If a mismatch between the basis in the long period and the linear combination coefficient in the short period occurs when the access network device restores the precoding matrix, the precoding matrix is inaccurate, and a performance loss occurs.

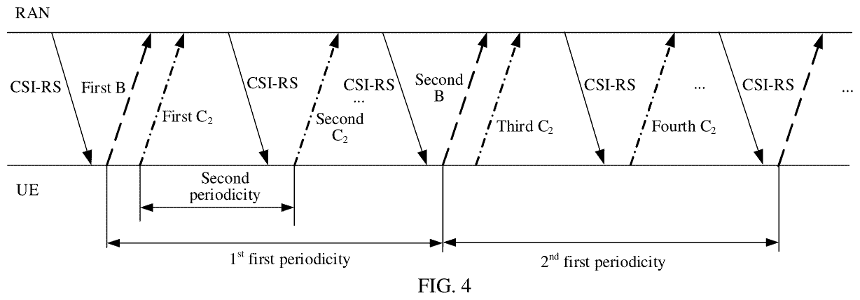

FIG. 4 is a schematic flowchart of air interface interaction of CSI when a statistical eigen subspace codebook is used. A terminal device feeds back a first basis B of statistical eigen subspace based on a CSI report amount in a long period (namely, a first period), and feeds back, based on a CSI report amount in a short period (namely, a second period), a linear combination coefficient C₂ corresponding to the first basis B. An access network device sends a channel state information-reference signal (CSI-RS) to the terminal device in the second period. The terminal device receives the CSI-RS in each second period, determines the first basis B of the statistical eigen subspace based on CSI-RS measurement results in a current short period and a plurality of historical short periodicities, and feeds back the first basis B to the access network device in the first period. In addition, the terminal device determines the linear combination coefficient C₂ based on a CSI-RS measurement result in a short period and the first basis B of the statistical eigen subspace, and feeds back the linear combination coefficient C₂ to the access network device in the second period. FIG. 4 shows an air interface interaction process in two first periodicities. In a start phase of a 1^{st} first period, UE receives a CSI-RS sent by a RAN device, and the UE determines a first basis B of the statistical eigen subspace based on a current CSI-RS measurement result and a plurality of historical CSI-RS measurement results, and feeds back the first basis B (refer to a first B in FIG. 4) to the RAN device. In the 1^{st} first period, the UE determines linear combination coefficients C₂ based on CSI-RS measurement results in a plurality of second periodicities and the first basis B (refer to the first B in FIG. 4) of the statistical eigen subspace, and feeds back the linear combination coefficients C₂ (refer to a first C₂ and a second C₂ in FIG. 4) to the RAN device in the second period. The RAN device separately determines, based on the first B and the linear combination coefficients C₂ (for example, the first C₂ and the second C₂) received in the plurality of second periodicities within the 1^{st} first period, precoding matrices corresponding to the plurality of second periodicities (for example, a precoding matrix determined based on the first B and the first C₂ and a precoding matrix determined based on the first B and the second C₂). In a start phase of a 2^{nd} first period, the UE receives the CSI-RS sent by the RAN device, and the UE determines a first basis B of the statistical eigen subspace based on a current CSI-RS measurement result and a plurality of historical CSI-RS measurement results, and feeds back the first basis B (refer to a second B in FIG. 4) to the RAN device. In the 2^{nd} first period, the UE determines linear combination coefficients C₂ based on CSI-RS measurement results in a plurality of second periodicities and the first basis B (refer to the second B in FIG. 4) of the statistical eigen subspace, and feeds back the linear combination coefficients C₂ (refer to a third C₂ and a fourth C₂ in FIG. 4) to the RAN device in the second period. The RAN device separately determines, based on the second B and the linear combination coefficients C₂ (for example, the third C₂ and the fourth C₂) received in the plurality of second periodicities within the 2^{nd} first period, precoding matrices corresponding to the plurality of second periodicities (for example, a precoding matrix determined based on the second B and the third C₂ and a precoding matrix determined based on the second B and the fourth C₂).

It should be understood that, in this embodiment of this application, the CSI-RS is only used as an example for description, but is not limited to the CSI-RS. The access network device may further measure another reference signal, for example, a synchronization signal block (SSB), a demodulation reference signal (DMRS), and a cell reference signal (CRS), by configuring the terminal device. Therefore, the terminal device feeds back, based on the CSI report amount in the long period (namely, the first period), the first basis B that is of the statistical eigen subspace and that is obtained through measurement, and feeds back, based on the CSI report amount in the short period (namely, the second period), the linear combination coefficient C₂ corresponding to the first basis B.

It should be noted that, due to a channel change, the first basis B fed back by the UE in the 1^{st} first period may be different from the first basis B fed back in the 2^{nd} first period. Similarly, the linear combination coefficients C₂ fed back by the UE in each second period may also be different.

It may be learned that a period for sending the CSI-RS by the access network device to the terminal device is the second period, a period for feeding back the first basis B of the statistical eigen subspace by the terminal device to the access network device is the first period, the first basis B that is of the statistical eigen subspace and that is fed back by the terminal device to the access network device is a result of a plurality of accumulated times of measurement, and a period for feeding back the linear combination coefficient C₂ by the terminal device to the access network device is the second period. For example, the period for sending the CSI-RS by the access network device to the terminal device is 5 ms, the period for feeding back the first basis B of the statistical eigen subspace by the terminal device to the access network device is 200 ms, and the period for feeding back the linear combination coefficient C₂ by the terminal device to the access network device is 5 ms.

The terminal device calculates the first basis B of the statistical eigen subspace based on a channel measurement result in the long period, and reports the first basis B. In addition, before a new statistical eigen subspace basis is calculated in the long period next time, the terminal device calculates a linear combination coefficient C₂ in the short period based on a current first basis B of the statistical eigen subspace and the channel measurement result, and reports the linear combination coefficient C₂ in the short period. For the access network device, after receiving a current CSI report amount in the long period, the access network device updates, based on the report amount, a statistical eigen subspace basis stored in the access network device to the first basis B. Then, before receiving a report amount in the long period next time, the access network device restores the precoding matrix based on both a current first basis B of the statistical eigen subspace and a linear combination coefficient C₂ that is in the short period and that is determined based on each CSI report amount in the short period.

Therefore, it may be learned that calculation of the linear combination coefficient in the short period by the terminal device is related to the statistical eigen subspace basis, and whether the statistical eigen subspace basis in the long period and the linear combination coefficient in the short period that are used by the access network device to restore the precoding matrix are matched greatly affects accuracy of the precoding matrix.

An update and alignment manner of the statistical eigen subspace basis of the access network device and the terminal device in the long period mainly has the following two problems:
(1) After the terminal device reports a current first basis B of the statistical eigen subspace in the long period, before a new statistical eigen subspace basis is calculated in the long period next time, the terminal device calculates and reports a linear combination coefficient in the short period based on the current first basis B of the eigen subspace. However, in an actual system, it takes a period of time from sending the report amount in the long period by the terminal device to receiving and successfully restoring the first basis B of the statistical eigen subspace in the long period by the access network device. In this period of time, restoring of the precoding matrix by the access network device by using a received linear combination coefficient C₂ in the short period is based on an eigen subspace basis updated in a previous long period. Therefore, a problem that the linear combination coefficient in the short period does not match the statistical eigen subspace basis exists. This results in a performance loss.
(2) A loss or a decoding error may occur when the access network device receives both the CSI report amount in the long period and the CSI report amount in the short period. If the report amount in the short period is incorrectly decoded or lost, only a current restoration result of the precoding matrix is affected. However, if the access network device fails to correctly decode the report amount in the long period, the access network device restores the precoding matrix in a subsequent long period by using a statistical eigen subspace basis in a previous period. In this case, a linear combination coefficient reported by the terminal device in the short period is obtained through calculation based on a current first basis B of the statistical eigen subspace, so that when the access network device restores the precoding matrix in an entire current long period, a problem that the linear combination coefficient in the short period does not match the statistical eigen subspace basis exists. In this case, a performance loss in the entire long period is caused.

In conclusion, in the foregoing two cases, there is a possibility of a performance loss because the linear combination coefficient in the short period does not match the eigen subspace basis in the long period.

Therefore, this application provides a channel information feedback method, to resolve a problem of a performance loss caused by an inaccurate precoding matrix due to a mismatch between a linear combination coefficient in a short period and a space-frequency joint basis in a long period.

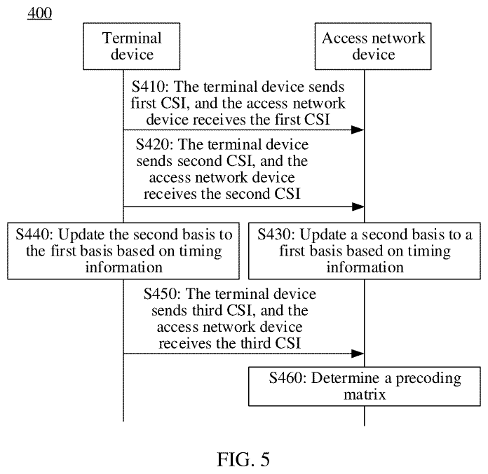

The following describes in detail a channel information feedback method according to this application with reference to FIG. 5. FIG. 5 is a schematic flowchart of a channel state information feedback method 400 according to this application. The method 400 may be applied to the foregoing application scenario. It is clear that the method 400 may alternatively be applied to another communication scenario. This is not limited in this application.

It should be further understood that, in this embodiment of this application, the method is described by using an example in which the method is performed by an access network device and a terminal device. By way of example and not limitation, the method may alternatively be performed by chips, chip systems, processors, or the like used in the terminal device and the access network device.

As shown in FIG. 5, the method 400 shown in FIG. 5 may include S410 to S460. The following describes steps in the method 400 in detail with reference to FIG. 5.
S410: The terminal device sends first CSI to the access network device, and correspondingly, the access network device receives the first CSI from the terminal device. The first CSI includes indication information of a first basis of statistical eigen subspace, a period for sending the first CSI by the terminal device is a first period, and the first basis indicates a change rule of a downlink channel in space domain and/or frequency domain, or the first basis indicates a change rule of a downlink channel in joint space-frequency domain.

It should be understood that the indication information of the first basis directly or indirectly indicates the first basis, or may indicate a part or all of the first basis. The first basis may be determined based on the indication information of the first basis. For example, a mapping relationship between the indication information and the first basis may be pre-established, and the mapping relationship between the indication information and the first basis is stored in the access network device and the terminal device. The terminal device sends the indication information of the first basis to the access network device. After receiving the indication information of the first basis, the access network device determines the first basis based on the mapping relationship between the indication information and the first basis. In this way, signaling overheads can be reduced.

The terminal device periodically sends the first CSI to the access network device, and the sending period is the first period. To be specific, the terminal device sends the first CSI to the access network device at a start moment or an end moment of each first period.

It should be understood that the first basis may indicate the change rule of the downlink channel in space domain and/or frequency domain by using a vector or a vector group, or the first basis may indicate the change rule of the downlink channel in joint space-frequency domain by using a vector or a vector group.
S420: The terminal device sends second CSI to the access network device, and correspondingly, the access network device receives the second CSI from the terminal device. The second CSI includes indication information of a first linear combination coefficient. A period for sending the second CSI by the terminal device is a second period, and the first linear combination coefficient is a combination coefficient corresponding to a second basis.

It should be understood that the indication information of the first linear combination coefficient directly or indirectly indicates the first linear combination coefficient, or may indicate a part or all of the first linear combination coefficient. The first linear combination coefficient may be determined based on the indication information of the first linear combination coefficient. For example, a mapping relationship between the indication information and the first linear combination coefficient may be pre-established, and the mapping relationship between the indication information and the first linear combination coefficient is stored in the access network device and the terminal device. The terminal device sends the indication information of the first linear combination coefficient to the access network device. After receiving the indication information of the first linear combination coefficient, the access network device determines the first linear combination coefficient based on the mapping relationship between the indication information and the first linear combination coefficient. In this way, signaling overheads can be reduced.

The first linear combination coefficient matches the second basis of the statistical eigen subspace. It should be understood that a statistical eigen subspace basis used when the terminal device sends the second CSI is the second basis, the second basis is reported to the access network device in a first period before a first period at which the terminal device sends the second CSI, and the first basis is reported to the access network device in the first period at which the terminal device sends the second CSI, that is, the second basis is a previous first basis.

The terminal device sends the second CSI to the access network device in the second period. To be specific, the terminal device sends the second CSI to the access network device at a start moment or an end moment of each second period. It should be noted that a duration of the first period and a duration of the second period may be determined by the access network device, and the duration of the first period and the duration of the second period are sent to the terminal device by using configuration information.

In a possible implementation, the access network device sends a CSI-RS to the terminal device in the second period, the terminal device sends the first CSI to the access network device in the first period, and the terminal device sends the second CSI to the access network device in the second period. In another possible implementation, the access network device sends, to the terminal device in the first period, first trigger information for reporting the first CSI. After receiving the first trigger information, the terminal device sends the first CSI to the access network device. The access network device sends, to the terminal device in the second period, second trigger information for reporting the second channel state information. After receiving the second trigger information, the terminal device sends the second CSI to the access network device.

It should be understood that the first CSI and the second CSI may be simultaneously reported, or may be separately reported. In other words, the indication information of the first basis and the indication information of the first linear combination coefficient may be reported in one piece of CSI, or may be reported in different pieces of CSI.

In this case, a statistical eigen subspace basis used by the access network device is also the second basis, and the second basis is obtained by the access network device based on previous first CSI. In this case, the access network device determines a precoding matrix based on the second basis and the first linear combination coefficient.

It should be understood that, in S420, a basis used when the access network device determines the precoding matrix is the second basis, and the terminal device reports the second CSI based on the second basis.
S430: The access network device updates the second basis of the statistical eigen subspace to the first basis based on timing information.
S440: The terminal device updates the second basis of the statistical eigen subspace to the first basis based on timing information.

In a possible implementation, the timing information may be implemented by a timer. For example, a duration is 20 ms. A duration of the timing information configured on the access network device may be the same as or different from the duration of the timing information configured on the terminal device. For example, when information propagation time between the terminal device and the access network device and time for parsing the first CSI on the access network device are considered, the duration of the timing information on the access network device may be greater than the duration of the timing information on the terminal device. For another example, when information propagation time between the terminal device and the access network device and time for parsing the first CSI on the access network device are not considered, the duration of the timing information on the access network device may be equal to the duration of the timing information on the terminal device.

An objective of using the timing information is to enable the terminal device and the access network device to jointly update the second basis of the statistical eigen subspace to the first basis. There may be a plurality of implementations of configuring the timing information for the terminal device and the access network device.

Optionally, the timing information is timing information preconfigured on the access network device and the terminal device. For example, as specified in a communication protocol, the timing information is known to both the access network device and the terminal device.

Optionally, the timing information is determined by the access network device, and is sent to the terminal device by using the configuration information.

Optionally, the timing information is determined by the terminal device, and is reported to the access network device. It should be understood that, before the terminal device and the access network device synchronously update the second basis to the first basis, the terminal device periodically sends the second CSI to the access network device. Correspondingly, the access network device periodically receives the second CSI sent by the terminal device.
S450: The terminal device sends third CSI to the access network device, and correspondingly, the access network device receives the third CSI from the terminal device.

The third CSI includes indication information of a second linear combination coefficient, and the third CSI is generated by the terminal device based on the updated second basis (namely, the first basis), that is, the terminal device generates the third CSI based on a first basis indicated by first CSI closest to a current moment. A period for sending the third CSI by the terminal device is the second period.

After both the terminal device and the access network device update the second basis to the first basis, the terminal device periodically sends the third CSI to the access network device. Correspondingly, the access network device periodically receives the third CSI from the terminal device. For example, the access network device sends the CSI-RS to the terminal device in the second period. After receiving the CSI-RS, the terminal device sends the third CSI to the access network device also in the second period.

The access network device parses the third CSI sent by the terminal device, obtains the indication information of the second linear combination coefficient, and determines the second linear combination coefficient.
S460: The access network device determines the precoding matrix based on the first basis and the second linear combination coefficient.

In the method 400, the access network device and the terminal device jointly update a statistical eigen subspace basis based on the timing information, so that the second linear combination coefficient that is reported in the second period and that is obtained by the access network device can match the first basis that is of the statistical eigen subspace and that is used to restore the precoding matrix. This improves accuracy of the precoding matrix, and improves system performance.

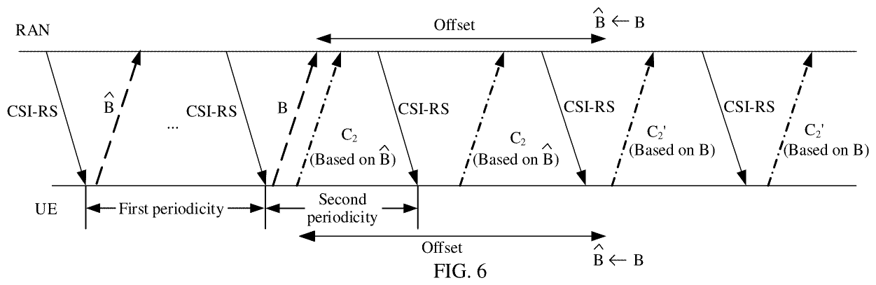

To understand the method 400 more clearly, the following then uses a schematic flowchart of air interface interaction between the access network device and the terminal device for description. FIG. 6 is a schematic flowchart of air interface interaction between an access network device and a terminal device according to this application. As shown in FIG. 6, in a 1^{st} first period, the access network device sends a CSI-RS to the terminal device in a second period. The terminal device receives the CSI-RS. The terminal device determines a second basis \hat{B} of statistical eigen subspace based on a result of current downlink channel measurement and results of one or more times of downlink channel measurement before the current measurement. The terminal device feeds back the second basis \hat{B} to the access network device at a start moment of the 1^{st} first period. It should be understood that, in the 1^{st} first period, the access network device and the terminal device also update a basis. For this process, refer to the following descriptions of updating the basis by the access network device and the terminal device in a 2^{nd} first period. It should be further understood that, in the 1^{st} first period, the access network device receives, in the second period, a first linear combination coefficient fed back by the terminal device. In the 2^{nd} first period, the access network device sends the CSI-RS to the terminal device in the second period. The terminal device receives the CSI-RS. The terminal device determines a first basis B of the statistical eigen subspace based on a result of current downlink channel measurement and results of one or more times of downlink channel measurement before the current measurement, and feeds back the first basis B to the access network device at a start moment of the 2^{nd} first period. The terminal device determines a first linear combination coefficient C₂ based on the result of the current downlink channel measurement and a previous second basis \hat{B} of the statistical eigen subspace, and feeds back the first linear combination coefficient C₂ to the access network device. It should be understood that the terminal device may feed back the first basis B and the first linear combination coefficient C₂ in one message, or may separately feed back the first basis B and the first linear combination coefficient C₂. The access network device currently uses the second basis \hat{B}, and the access network device determines a precoding matrix based on the previous second basis \hat{B} of the statistical eigen subspace and the first linear combination coefficient C₂. The terminal device starts timing of a timer of the terminal device based on timing information (for example, after the terminal device sends the first basis B to the access network device), and the access network device starts timing of a timer of the access network device based on timing information (for example, the access network device starts the timing when receiving the first basis B fed back by the terminal device). The access network device sends the CSI-RS to the terminal device in the second period. The terminal device receives the CSI-RS, and feeds back the first linear combination coefficient C₂ to the access network device based on a measurement result. The access network device still determines the precoding matrix based on the second basis \hat{B} and the first linear combination coefficients C₂. When the timing information of the terminal device and the timing information of the access network device expire, the access network device and the terminal device simultaneously update the second basis \hat{B} to the first basis B. The terminal device and the access network device reset respective timers. Then, the terminal device reports a second linear combination coefficient C′₂ to the access network device based on the first basis B. The access network device determines the precoding matrix based on the first basis B obtained through the update and the second linear combination coefficient C′₂ reported by the terminal device. The procedure described in FIG. 6 is performed after the terminal device feeds back a statistical eigen subspace basis in a next first period. The access network device and the terminal device update the statistical eigen subspace basis based on the timing information, so that the access network device can match a corresponding statistical eigen subspace basis when receiving a linear combination coefficient in a short period. This resolves a problem that the linear combination coefficient in the short period does not match the statistical eigen subspace basis.

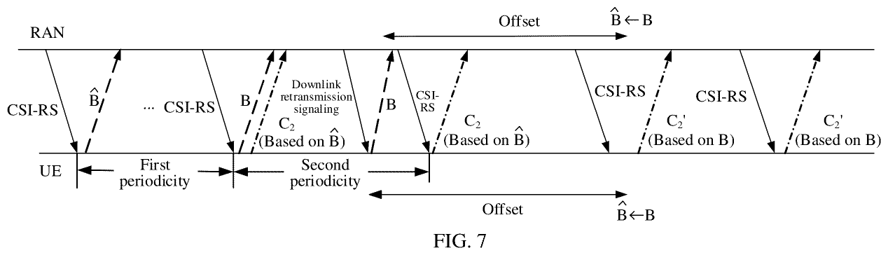

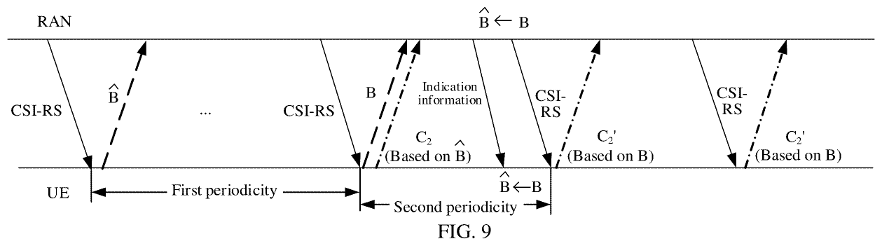

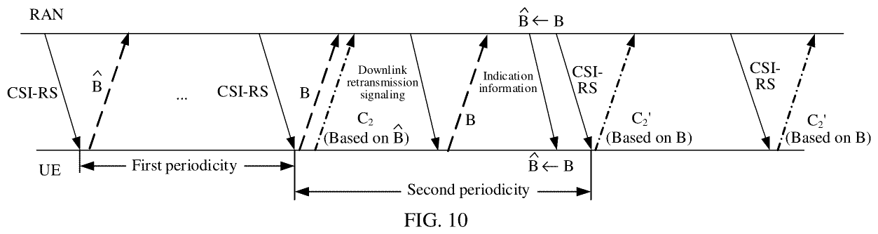

It should be understood that, in the foregoing descriptions of FIG. 6, that the terminal device reports a basis or a linear combination coefficient to the access network device is merely for ease of description. Generally, the terminal device does not report the basis or the linear combination coefficient to the access network device, but reports indication information of the basis or indication information of the linear combination coefficient. In this way, signaling overheads are reduced. FIG. 7, FIG. 9, and FIG. 10 are also for ease of description, and do not constitute any limitation on this application.

It should be further understood that, for descriptions of the first period and the second period in FIG. 6, refer to the descriptions of the first period and the second period in FIG. 4.

In a possible implementation, a case in which the access network device does not obtain indication information of the first basis exists. For example, the access network device does not receive current first CSI; or the access network device receives current first CSI, but fails to parse the current first CSI, and does not obtain the indication information of the first basis. When the access network device does not obtain the indication information of the first basis, the method 400 may further include: The access network device sends retransmission signaling to the terminal device, where the retransmission signaling indicates the terminal device to retransmit first CSI. The terminal device receives the retransmission signaling. The terminal device retransmits the first CSI to the access network device.

For example, after sending the first CSI to the access network device, the terminal device starts the timing information. The terminal device receives the retransmission signaling within a duration of the timing information. The terminal device stops current timing. The terminal device restarts the timer again after retransmitting the first CSI to the access network device. The access network device receives the retransmission signaling sent by the terminal device, to obtain the indication information of the first basis, and restarts the timer again. When time of the timer that is restarted again expires, the access network device and the terminal device simultaneously update the second basis to the first basis.

For another example, after sending the first CSI to the access network device, the terminal device starts the timing information. The terminal device receives the retransmission signaling within a duration of the timing information. The terminal device retransmits the first CSI to the access network device. The access network device receives the retransmission signaling sent by the terminal device, to obtain the indication information of the first basis. When time of the timer expires, the access network device and the terminal device simultaneously update the second basis to the first basis. When neither the terminal device nor the access network device restarts the timer, the duration of the timer should be set to be long. For example, the duration of the timer is greater than a propagation delay of the retransmission signaling.

When the access network device does not obtain the indication information of the first basis, the access network device sends the retransmission signaling to the terminal device to indicate the terminal device to retransmit the first CSI, so that the indication information of the first basis is re-obtained. Then, the access network device and the terminal device update the second basis of the statistical eigen subspace to the first basis based on the timing information. Therefore, the second linear combination coefficient obtained by the access network device based on received indication information that is of the second linear combination coefficient and that is reported in the second period can match the first basis that is of the statistical eigen subspace and that is used to restore the precoding matrix. This improves accuracy of the precoding matrix and improves system performance.

Optionally, the retransmission signaling may be sent by using radio resource control (RRC) signaling, media access control-control element (MAC-CE) signaling, or downlink control information (DCI).

To understand a process in which the terminal device and the access network device update the statistical eigen subspace basis when the access network device sends the retransmission signaling more clearly, the following then uses a schematic flowchart of air interface interaction between the access network device and the terminal device for description. FIG. 7 is a schematic flowchart of air interface interaction between an access network device and a terminal device according to this application. As shown in FIG. 7, in a 1^{st} first period, the access network device sends a CSI-RS to the terminal device in a second period. The terminal device receives the CSI-RS. The terminal device determines a second basis \hat{B} of statistical eigen subspace based on a result of current downlink channel measurement and results of one or more times of downlink channel measurement before the current measurement. The terminal device feeds back the second basis \hat{B} to the access network device at a start moment of the 1^{st} first period (which may be considered as the 1^{st} first period). It should be understood that, in the 1^{st} first period, the access network device and the terminal device also update a basis. For this process, refer to the following descriptions of updating the basis by the access network device and the terminal device in a 2^{nd} first period. It should be further understood that, in the 1^{st} first period, the access network device receives, in the second period, a first linear combination coefficient fed back by the terminal device. In the 2^{nd} first period, the access network device sends the CSI-RS to the terminal device in the second period. The terminal device receives the CSI-RS. The terminal device determines a first basis B of the statistical eigen subspace based on a result of current downlink channel measurement and results of one or more times of downlink channel measurement before the current measurement, and feeds back the first basis B to the access network device at a start moment of the 2^{nd} first period. The terminal device determines a first linear combination coefficient C₂ based on the result of the current downlink channel measurement and a previous second basis \hat{B} of the statistical eigen subspace, and feeds back the first linear combination coefficient C₂ to the access network device. In this case, the access network device currently uses the second basis \hat{B}. The access network device determines a precoding matrix based on the second basis \hat{B} and the first linear combination coefficient C₂. If the access network device fails to obtain the first basis B, the access network device sends retransmission signaling to the terminal device. The terminal device receives the retransmission signaling sent by the access network device, and retransmits the first basis B of the statistical eigen subspace to the access network device. In this case, the terminal device starts timing based on timing information after sending the retransmission signaling, and the access network device starts timing based on timing information after receiving the retransmission signaling. The access network device sends the CSI-RS to the terminal device in the second period. The terminal device receives the CSI-RS, and feeds back the first linear combination coefficient C₂ to the access network device based on a measurement result. The terminal device still determines the precoding matrix based on the previous second basis \hat{B} of the statistical eigen subspace and the first linear combination coefficient C₂. When the timing information of the terminal device and the timing information of the access network device expire, the access network device and the terminal device simultaneously update the second basis \hat{B} to the first basis B. The terminal device and the access network device reset respective timers. Then, the terminal device reports a second linear combination coefficient C′₂ to the access network device based on the first basis B. The access network device determines the precoding matrix based on the first basis B obtained through the update and the second linear combination coefficient C′₂ reported by the terminal device. The procedure described in FIG. 7 is performed after the terminal device feeds back a statistical eigen subspace basis in a next first period. When the access network device does not obtain indication information of the first basis, the access network device sends the retransmission signaling to the terminal device to indicate the terminal device to retransmit current first channel state information, so that the indication information of the first basis is re-obtained. Then, the access network device and the terminal device update the second basis of the statistical eigen subspace to the first basis based on the timing information. Therefore, the access network device can match a corresponding statistical eigen subspace basis when receiving a linear combination coefficient in a short period. This resolves a problem that the linear combination coefficient in the short period does not match the statistical eigen subspace basis.

It should be further understood that, for descriptions of the first period and the second period in FIG. 7, refer to the descriptions of the first period and the second period in FIG. 4.

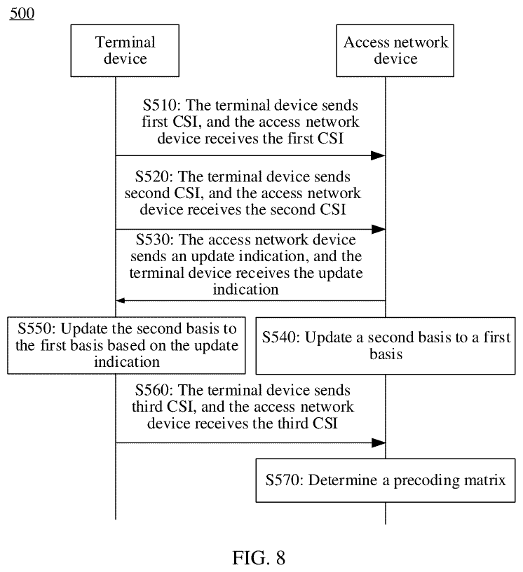

The following describes in detail another precoding matrix determining method 500 according to this application with reference to FIG. 8. FIG. 8 is a schematic flowchart of the precoding matrix determining method 500 according to this application. The method 500 may be applied to the foregoing application scenario. It is clear that the method 500 may alternatively be applied to another communication scenario. This is not limited in this application.

It should be further understood that, in this embodiment of this application, the method is described by using an example in which the method is performed by an access network device and a terminal device. By way of example and not limitation, the method may alternatively be performed by chips, chip systems, processors, or the like used in the terminal device and the access network device.

As shown in FIG. 8, the method 500 shown in FIG. 8 may include S510 to S570. The following describes steps in the method 500 in detail with reference to FIG. 8.
S510: The terminal device sends first CSI to the access network device, and correspondingly, the access network device receives the first CSI from the terminal device. The first CSI includes indication information of a first basis of statistical eigen subspace, a period for sending the first CSI by the terminal device is a first period, and the first basis indicates a change rule of a downlink channel in space domain and/or frequency domain, or the first basis further indicates a change rule of a downlink channel in joint space-frequency domain.

It should be understood that, for descriptions of the indication information of the first basis, refer to the descriptions of step S410 in the method 400.

The terminal device periodically sends the first CSI to the access network device, and the sending period is the first period. To be specific, the terminal device sends the first CSI to the access network device at a start moment or an end moment of each first period.

For descriptions of the first basis, refer to the corresponding descriptions in the method 400.
S520: The terminal device sends second CSI to the access network device, and correspondingly, the access network device receives the second CSI from the terminal device. The second CSI includes indication information of a first linear combination coefficient. A period for sending the second CSI by the terminal device is a second period, and the first linear combination coefficient is a combination coefficient corresponding to a second basis.

It should be understood that, for descriptions of the indication information of the first linear combination coefficient, refer to the descriptions of step S420 in the method 400.

The first linear combination coefficient matches the second basis of the statistical eigen subspace. It should be understood that a statistical eigen subspace basis used when the terminal device sends the second CSI is the second basis, the second basis is reported to the access network device in a first period before a first period at which the terminal device sends the second CSI, and the first basis is fed back to the access network device in the first period at which the terminal device sends the second CSI, that is, the second basis is a previous first basis.

The terminal device sends the second CSI to the access network device in the second period. To be specific, the terminal device sends the second CSI to the access network device at a start moment or an end moment of each second period. It should be noted that a duration of the first period and a duration of the second period may be determined by the access network device, and the duration of the first period and the duration of the second period are sent to the terminal device by using configuration information.

For descriptions of the first period and the second period, refer to related descriptions in the method 400.

It should be understood that the first CSI and the second CSI may be simultaneously reported, or may be separately reported. In other words, the indication information of the first basis and the indication information of the first linear combination coefficient may be reported in one piece of CSI, or may be reported in different pieces of CSI.

In this case, a statistical eigen subspace basis used by the access network device is also the second basis, and the second basis is obtained by the access network device based on previous first CSI. In this case, the access network device determines a precoding matrix based on the second basis and the first linear combination coefficient.

It should be understood that, in step S510 and step S520, a basis used when the access network device determines the precoding matrix is the second basis, and the terminal device reports the second CSI based on the second basis.
S530: The access network device sends update indication information to the terminal device, where the update indication information indicates the terminal device to update the second basis of the statistical eigen subspace to the first basis, and correspondingly, the terminal device receives the update indication information from the access network device.
S540: After the access network device sends the update indication information to the terminal device, the access network device updates the second basis of the statistical eigen subspace to the first basis.
S550: The terminal device updates the second basis of the statistical eigen subspace to the first basis based on the update indication information.
S560: The terminal device sends third CSI to the access network device, and correspondingly, the access network device receives the third CSI from the terminal device.

The third CSI includes indication information of a second linear combination coefficient, and the third CSI is generated by the terminal device based on the updated second basis (namely, the first basis), that is, the terminal device generates the third CSI based on a first basis indicated by first CSI closest to a current moment. A period for sending the third CSI by the terminal device is the second period.

After both the terminal device and the access network device update the second basis to the first basis, the terminal device periodically sends the third CSI to the access network device. Correspondingly, the access network device periodically receives the third CSI from the terminal device. For example, the access network device sends a CSI-RS to the terminal device in the second period. After receiving the CSI-RS, the terminal device sends the third CSI to the access network device also in the second period.

The access network device parses the third CSI sent by the terminal device, obtains the indication information of the second linear combination coefficient, and determines the second linear combination coefficient.
S570: The access network device determines the precoding matrix based on the first basis and the second linear combination coefficient.

In the method 500, when the access network device determines a new statistical eigen subspace basis, the access network device sends an update indication information to the terminal device to indicate the terminal device to update a statistical eigen subspace basis, and simultaneously, the access network device updates the second basis to the first basis. In this way, the access network device and the terminal device jointly update the statistical eigen subspace basis, so that the second linear combination coefficient that is reported in the second period and that is obtained by the access network device can match the first basis that is of the statistical eigen subspace and that is used to restore the precoding matrix. This improves accuracy of the precoding matrix and improves system performance.

To understand the method 500 more clearly, the following then uses a schematic flowchart of air interface interaction between the access network device and the terminal device for description. FIG. 9 is a schematic flowchart of air interface interaction between an access network device and a terminal device according to this application. As shown in FIG. 9, in a 1^{st} first period, the access network device sends a CSI-RS to the terminal device in a second period. The terminal device receives the CSI-RS. The terminal device determines a second basis \hat{B} of statistical eigen subspace based on a result of current downlink channel measurement and results of one or more times of downlink channel measurement before the current measurement. The terminal device feeds back the second basis \hat{B} to the access network device at a start moment of the 1^{st} first period (which may be considered as the 1^{st} first period). It should be understood that, in the 1^{st} first period, the access network device and the terminal device also update a basis. For this process, refer to the following descriptions of updating the basis by the access network device and the terminal device in a 2^{nd} first period. It should be further understood that, in the 1^{st} first period, the access network device receives, in the second period, a first linear combination coefficient fed back by the terminal device. In the 2^{nd} first period, the access network device sends the CSI-RS to the terminal device in the second period. The terminal device receives the CSI-RS. The terminal device determines a first basis B of the statistical eigen subspace based on a result of current downlink channel measurement and results of one or more times of downlink channel measurement before the current measurement, and feeds back the first basis B to the access network device at a start moment of the 2^{nd} first period. The terminal device determines a first linear combination coefficient C₂ based on the result of the current downlink channel measurement and a previous second basis \hat{B} of the statistical eigen subspace, and feeds back the first linear combination coefficient C₂ to the access network device. It should be understood that the terminal device may feed back the first basis B and the first linear combination coefficient C₂ in one message, or may separately feed back the first basis B and the first linear combination coefficient C₂. In this case, the access network device currently uses the second basis \hat{B}, and the access network device determines a precoding matrix based on the second basis \hat{B} and the first linear combination coefficient C₂. The access network device updates the second basis \hat{B} to the first basis B, and the access network device sends an update indication information to the terminal device to indicate the terminal device to update the second basis \hat{B} to the first basis B. After receiving the indication information, the terminal device updates the second basis \hat{B} to the first basis B. Then, the terminal device reports a second linear combination coefficient C′₂ to the access network device based on the first basis B. The access network device determines the precoding matrix based on the first basis B and the second linear combination coefficient C′₂ reported by the terminal device. The procedure described in FIG. 9 is performed after the terminal device feeds back a statistical eigen subspace basis in a next first period.

It should be further understood that, for descriptions of the first period and the second period in FIG. 9, refer to the descriptions of the first period and the second period in FIG. 4.

Optionally, the indication information may be sent by using radio resource control (RRC) signaling, media access control-control element (MAC-CE) signaling, or downlink control information (DCI).

In a possible implementation, a case in which the access network device does not obtain indication information of the first basis exists. For example, the access network device does not receive current first channel state information; or the access network device receives current first channel state information, but fails to parse the current first channel state information, and does not obtain the indication information of the first basis. When the access network device does not obtain the indication information of the first basis, the method 500 may further include: The access network device sends retransmission signaling to the terminal device, where the retransmission signaling indicates the terminal device to retransmit first channel state information. The terminal device receives the retransmission signaling and retransmits the first channel state information to the access network device. The access network device receives the first channel state information retransmitted by the terminal device, to obtain the indication information of the first basis. After the access network device obtains the indication information of the first basis, the access network device sends the indication information to the terminal device, where the indication information indicates the terminal device to update the second basis of the statistical eigen subspace to the first basis. After the access network device sends the indication information to the terminal device, the access network device updates the second basis of the statistical eigen subspace to the first basis.

When the access network device does not obtain the indication information of the first basis, the access network device sends the retransmission signaling to the terminal device to indicate the terminal device to retransmit the first channel state information, so that the indication information of the first basis is re-obtained. Then, when the access network device determines a new statistical eigen subspace basis, the access network device sends the indication information to the terminal device to indicate the terminal device to update the statistical eigen subspace basis, so that the access network device and the terminal device can synchronously update the statistical eigen subspace basis. Therefore, the second linear combination coefficient obtained by the access network device based on received indication information that is of the second linear combination coefficient and that is reported in the second period can match the first basis that is of the statistical eigen subspace and that is used to restore the precoding matrix. This improves accuracy of the precoding matrix and improves system performance.

To understand a process in which the terminal device and the access network device update the statistical eigen subspace basis when the access network device sends the retransmission signaling more clearly, the following then uses a schematic flowchart of air interface interaction between the access network device and the terminal device for description. FIG. 10 is a schematic flowchart of air interface interaction between an access network device and a terminal device according to this application. As shown in FIG. 10, in a 1^{st} first period, the access network device sends a CSI-RS to the terminal device in a second period. The terminal device receives the CSI-RS. The terminal device determines a second basis \hat{B} of statistical eigen subspace based on a result of current downlink channel measurement and results of one or more times of downlink channel measurement before the current measurement. The terminal device feeds back the second basis \hat{B} to the access network device at a start moment of the 1^{st} first period (which may be considered as the 1^{st} first period). It should be understood that, in the 1^{st} first period, the access network device and the terminal device also update a basis. For this process, refer to the following descriptions of updating the basis by the access network device and the terminal device in a 2^{nd} first period. It should be further understood that, in the 1^{st} first period, the access network device receives, in the second period, a first linear combination coefficient fed back by the terminal device. In the 2^{nd} first period, the access network device sends the CSI-RS to the terminal device in the second period. The terminal device receives the CSI-RS. The terminal device determines a first basis B of the statistical eigen subspace based on a result of current downlink channel measurement and results of one or more times of downlink channel measurement before the current measurement, and feeds back the first basis B to the access network device at a start moment of the 2^{nd} first period. The terminal device determines a first linear combination coefficient C₂ based on the result of the current downlink channel measurement and a previous second basis \hat{B} of the statistical eigen subspace, and feeds back the first linear combination coefficient C₂ to the access network device. In this case, the access network device currently uses the second basis \hat{B}. The access network device determines a precoding matrix based on the second basis \hat{B} and the first linear combination coefficient C₂. If the access network device fails to obtain the first basis B, the access network device sends retransmission signaling to the terminal device. The terminal device receives the retransmission signaling sent by the access network device, and retransmits the first basis B of the statistical eigen subspace to the access network device. After the access network device obtains the first basis B, the access network device updates the second basis \hat{B} to the first basis B, and the access network device sends an update indication information to the terminal device to indicate the terminal device to update the second basis \hat{B} to the first basis B. After receiving the indication information, the terminal device updates the second basis \hat{B} to the first basis B. Then, the terminal device reports a second linear combination coefficient C′₂ to the access network device based on the first basis B. The access network device determines the precoding matrix based on the first basis B and the second linear combination coefficient C′₂ reported by the terminal device. The procedure described in FIG. 10 is performed after the terminal device feeds back a statistical eigen subspace basis in a next first period.

It should be further understood that, for descriptions of the first period and the second period in FIG. 10, refer to the descriptions of the first period and the second period in FIG. 4.

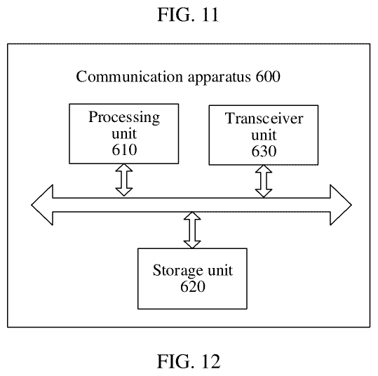

FIG. 11 is a diagram of module interaction between a terminal device and an access network device according to this application. The access network device and the terminal device each include an RRC signaling exchange module, a MAC signaling exchange module, and a port physical layer (PHY) signaling and data exchange module. The RRC signaling exchange module is a module used by the access network device and the terminal device to send and receive RRC signaling. The MAC signaling exchange module is a module used by the access network device and the terminal device to send and receive MAC-CE signaling. The PHY signaling and data exchange module is a module used by the access network device and the terminal device to send and receive downlink control signaling and downlink data. The downlink control signaling may be sent and received through a downlink control channel (PDCCH), and the downlink data may be sent and received through a physical downlink shared channel (PDSCH).

Both indication information and retransmission signaling in this application may be sent by using the RRC signaling, the MAC-CE signaling, or DCI.

The foregoing describes in detail methods in embodiments of this application with reference to FIG. 1 to FIG. 11. The following describes in detail communication apparatuses in embodiments of this application with reference to FIG. 12 to FIG. 14.

FIG. 12 is a block diagram of a communication apparatus 600 according to an embodiment of this application.

In some embodiments, the apparatus 600 may be a terminal device, or may be a chip or a circuit, for example, a chip or a circuit that may be disposed in a terminal device.

In some embodiments, the apparatus 600 may be an access network device, or may be a chip or a circuit, for example, a chip or a circuit that may be disposed in an access network device.

In a possible manner, the apparatus 600 may include a processing unit 610 (that is, an example of a processor) and a transceiver unit 630. In some possible implementations, the processing unit 610 may be further referred to as a determining unit. In some possible implementations, the transceiver unit 630 may include a receiving unit and a sending unit.

Optionally, the transceiver unit 630 may be implemented by a transceiver, a transceiver-related circuit, or an interface circuit.

Optionally, the apparatus may further include a storage unit 620. In a possible manner, the storage unit 620 is configured to store instructions. Optionally, the storage unit may also be configured to store data or information. The storage unit 620 may be implemented by a memory.

In some possible designs, the processing unit 610 is configured to execute the instructions stored in the storage unit 620, to enable the apparatus 600 to implement steps performed by the terminal device in the foregoing method. Alternatively, the processing unit 610 may be configured to invoke the data in the storage unit 620, to enable the apparatus 600 to implement steps performed by the terminal device in the foregoing method.

In some possible designs, the processing unit 610 is configured to execute the instructions stored in the storage unit 620, to enable the apparatus 600 to implement steps performed by the access network device in the foregoing method. Alternatively, the processing unit 610 may be configured to invoke the data in the storage unit 620, to enable the apparatus 600 to implement steps performed by the access network device in the foregoing method.

For example, the processing unit 610, the storage unit 620, and the transceiver unit 630 may communicate with each other through an internal connection path, to transfer a control signal and/or a data signal. For example, the storage unit 620 is configured to store a computer program, and the processing unit 610 may be configured to invoke the computer program from the storage unit 620 and run the computer program, to control the transceiver unit 630 to receive a signal and/or send a signal, so that steps of the terminal device or the access network device in the foregoing method are completed. The storage unit 620 may be integrated into the processing unit 610, or may be disposed separately from the processing unit 610.

Optionally, if the apparatus 600 is a communication device (for example, the terminal device or the access network device), the transceiver unit 630 includes a receiver and a transmitter. The receiver and the transmitter may be a same physical entity or different physical entities. When the receiver and the transmitter are a same physical entity, the receiver and the transmitter may be collectively referred to as a transceiver.

Optionally, if the apparatus 600 is a chip or a circuit, the transceiver unit 630 includes an input interface and an output interface.

In an implementation, it may be considered that a function of the transceiver unit 630 is implemented by a transceiver circuit or a dedicated transceiver chip. It may be considered that the processing unit 610 is implemented by a dedicated processing chip, a processing circuit, a processing unit, or a general-purpose chip.

In another implementation, it may be considered that the communication device (for example, the terminal device or the access network device) provided in embodiments of this application is implemented by a general-purpose computer. In other words, program code for implementing functions of the processing unit 610 and the transceiver unit 630 is stored in the storage unit 620, and a general-purpose processing unit implements the functions of the processing unit 610 and the transceiver unit 630 by executing the code in the storage unit 620.

In some embodiments, the apparatus 600 may be a terminal device, or a chip or a circuit disposed in a terminal device.

When the apparatus 600 is the terminal device, or the chip or the circuit disposed in the terminal device, the transceiver unit 630 is configured to send first channel state information to the access network device, where the first channel state information includes indication information of a first basis of statistical eigen subspace, and a period for sending the first channel state information by the terminal device is a first period. The transceiver unit 630 is further configured to: before the terminal device updates a second basis to the first basis, send second channel state information to the access network device, where the second channel state information includes indication information of a first linear combination coefficient, a period for sending the second channel state information by the transceiver unit 630 is a second period, the first period is greater than the second period, and the first linear combination coefficient is a combination coefficient corresponding to the second basis. The second channel state information is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The processing unit 610 is configured to update the second basis to the first basis based on trigger information. The transceiver unit 630 is further configured to: after the terminal device updates the second basis to the first basis, send third channel state information to the access network device, where the third channel state information includes indication information of a second linear combination coefficient, the third channel state information is generated by the terminal device based on the updated second basis, and a period for sending the third channel state information by the terminal device is the second period.

Optionally, the processing unit 610 is further configured to: when timing information reaches a specified time, update the second basis to the first basis.

Optionally, the timing information is obtained by the transceiver unit 630 from the access network device by using configuration information, or the timing information is predefined.

Optionally, the transceiver unit 630 is configured to receive update indication information sent by the access network device, where the update indication information indicates the terminal device to update the second basis of the statistical eigen subspace to the first basis. The processing unit is specifically configured to update the second basis to the first basis based on the update indication information.

Optionally, the transceiver unit 630 is further configured to: receive retransmission signaling sent by the access network device, where the retransmission signaling indicates the terminal device to retransmit the first channel state information; and retransmit the first channel state information to the access network device based on the retransmission signaling.

Optionally, a duration of the timing information is information locally configured on the terminal device; or the transceiver unit receives the configuration information sent by the access network device, where the configuration information includes a duration of the first period, a duration of the second period, and the duration of the timing information.

Optionally, at least one of the update indication information, the configuration information, or the retransmission signaling is included in radio resource control (RRC) signaling, media access control-control element (MAC-CE) signaling, or downlink control information (DCI).

When the apparatus 600 is configured on the terminal device or is the terminal device, modules or units in the apparatus 600 may be configured to perform actions or processing processes performed by the terminal device in the foregoing method. To avoid repetition, detailed descriptions thereof are omitted herein.

In some embodiments, the apparatus 600 may be the access network device, or the chip or the circuit disposed in the access network device. When the apparatus 600 is the access network device, or the chip or the circuit disposed in the access network device, the transceiver unit 630 is configured to receive first channel state information sent by the terminal device, where the first channel state information includes indication information of a first basis of statistical eigen subspace, and a period for receiving the first channel state information by the transceiver unit 630 is a first period. The processing unit is configured to parse the first channel state information. The transceiver unit 630 is configured to receive second channel state information sent by the terminal device, where the second channel state information includes indication information of a first linear combination coefficient, a period for receiving the second channel state information by the transceiver unit 630 is a second period, the first period is greater than the second period, and the first linear combination coefficient is a combination coefficient corresponding to a second basis. A statistical eigen subspace basis currently used by the processing unit 610 is the second basis of the statistical eigen subspace, the second channel state information is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The processing unit is configured to parse the second channel state information. The processing unit 610 is configured to update the second basis to the first basis based on timing information. The transceiver unit 630 receives third channel state information sent by the terminal device, where the third channel state information includes indication information of a second linear combination coefficient, the third channel state information is generated by the terminal device based on the updated second basis, and a period for sending the third channel state information by the transceiver unit 630 is the second period. The processing unit 610 is configured to parse the third channel state information. The processing unit 610 is configured to determine a precoding matrix based on the first basis and the second linear combination coefficient.

Optionally, the timing information is determined by the access network device or predefined.

Optionally, when the timing information is determined by the access network device, the transceiver unit 630 is further configured to send configuration information to the terminal device.

Optionally, the transceiver unit 630 is further configured to: when the first basis is failed to be obtained, send retransmission signaling to the terminal device, where the retransmission signaling indicates the terminal device to retransmit the first channel state information; and receive the first channel state information retransmitted by the terminal device.

Optionally, that the access network device fails to obtain the first basis includes: The transceiver unit fails to receive the first channel state information. Alternatively, the processing unit fails to parse the first channel state information.

Optionally, a duration of the timing information is information locally configured on the access network device; or the transceiver unit sends indication information to the terminal device, where the indication information includes a duration of the first period, a duration of the second period, and the duration of the timing information.

Optionally, at least one of the configuration information or the retransmission signaling is included in radio resource control (RRC) signaling, media access control-control element (MAC-CE) signaling, or downlink control information (DCI).

When the apparatus 600 is configured on the access network device or is the access network device, modules or units in the apparatus 600 may be configured to perform actions or processing processes performed by the access network device in the foregoing method. To avoid repetition, detailed descriptions thereof are omitted herein.

In some embodiments, the apparatus 600 may be the access network device, or the chip or the circuit disposed in the access network device. When the apparatus 600 is the access network device, or the chip or the circuit disposed in the access network device, the transceiver unit 630 is configured to receive first channel state information sent by the terminal device, where the first channel state information includes indication information of a first basis of statistical eigen subspace, and a period for receiving the first channel state information by the transceiver unit 630 is a first period. The processing unit 610 is configured to parse the first channel state information. The transceiver unit 630 is configured to receive second channel state information sent by the terminal device, where the second channel state information includes indication information of a first linear combination coefficient, a period for receiving the second channel state information by the access network device is a second period, the first period is greater than the second period, and the first linear combination coefficient is a combination coefficient corresponding to a second basis. A statistical eigen subspace basis currently used by the processing unit 610 is the second basis of the statistical eigen subspace, the second channel state information is generated by the terminal device based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain. The processing unit 610 is configured to parse the second channel state information. The access network device updates the second basis to the first basis. The transceiver unit 630 sends update indication information to the terminal device, where the update indication information indicates the terminal device to update the second basis to the first basis. The transceiver unit 630 receives third channel state information sent by the terminal device, where the third channel state information includes indication information of a second linear combination coefficient, the third channel state information is generated by the terminal device based on the updated second basis, and a period for sending the third channel state information by the terminal device is the second period. The processing unit 610 is configured to parse the third channel state information. The processing unit 610 is configured to determine a precoding matrix based on the first basis and the second linear combination coefficient.

Optionally, the transceiver unit 630 is further configured to: when the first basis is failed to be obtained, send retransmission signaling to the terminal device, where the retransmission signaling indicates the terminal device to retransmit the first channel state information; and receive the first channel state information retransmitted by the terminal device.

Optionally, that the first basis is failed to be obtained includes: The transceiver unit 630 fails to receive the first channel state information. Alternatively, the processing unit 610 fails to parse the first channel state information.

Optionally, the access network device sends a duration of the first period and/or a duration of the second period to the terminal device by using second indication information.

Optionally, at least one of the update indication information or the retransmission signaling is sent by using radio resource control (RRC) signaling, media access control-control element (MAC-CE) signaling, or downlink control information (DCI).

For concepts, explanations, detailed descriptions, and other steps of the apparatus 600 that are related to the technical solutions provided in embodiments of this application, refer to the descriptions of the content in the foregoing method or other embodiments.

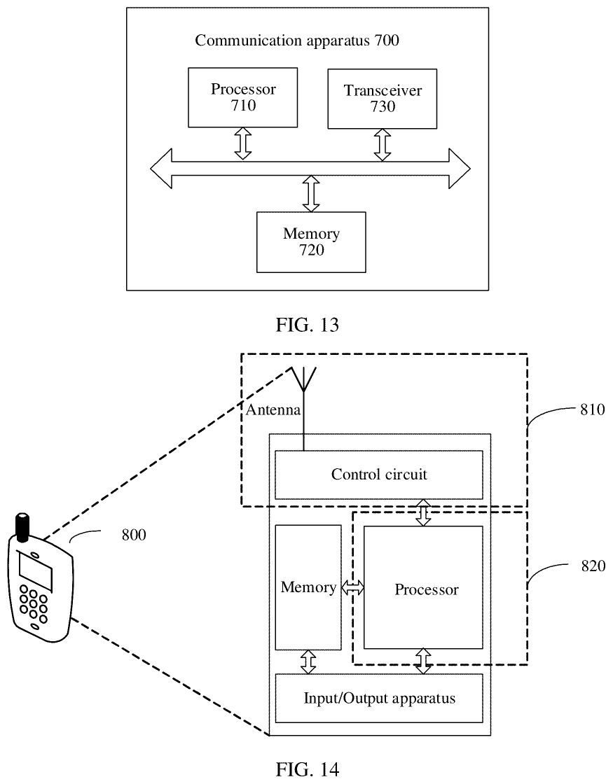

It should be noted that, in this application, the processing unit 610 may be implemented by a processor, the storage unit 620 may be implemented by a memory, and the transceiver unit 630 may be implemented by a transceiver. FIG. 13 is a diagram of a structure of a communication apparatus 700 according to this application. The communication apparatus 700 may include a processor 710, a memory 720, and a transceiver 730. The processor 710, the memory 720, and the transceiver 730 are respectively configured to implement functions of the processing unit 610, the storage unit 620, and the transceiver unit 630. Details are not described herein.

FIG. 14 is a diagram of a structure of a terminal device 800 according to this application. The terminal device 800 may perform the actions performed by the terminal device in the foregoing method embodiments.

For ease of description, FIG. 14 shows only main components of the terminal device. As shown in FIG. 14, the terminal device 800 includes a processor, a memory, a control circuit, an antenna, and an input/output apparatus.

The processor is mainly configured to process a communication protocol and communication data, control an entire terminal device, execute a software program, and process data of the software program, for example, is configured to support the terminal device to perform the actions described in the foregoing embodiments of an indication method for a precoding matrix used for transmission. The memory is mainly configured to store the software program and the data, for example, store a codebook described in the foregoing embodiments. The control circuit is mainly configured to: convert a baseband signal and a radio frequency signal and process the radio frequency signal. The control circuit and the antenna together may also be referred to as a transceiver, and are mainly configured to receive and send a radio frequency signal in a form of an electromagnetic wave. The input/output apparatus, such as a touchscreen, a display, or a keyboard, is mainly configured to: receive data input by a user and output data to the user.

After the terminal device is powered on, the processor may read the software program in the storage unit, interpret and execute instructions of the software program, and process data of the software program. When data needs to be sent wirelessly, the processor performs baseband processing on the to-be-sent data, and then outputs a baseband signal to a radio frequency circuit. The radio frequency circuit performs radio frequency processing on the baseband signal, and then sends, through the antenna, a radio frequency signal in an electromagnetic wave form. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data.

A person skilled in the art may understand that, for ease of description, FIG. 14 shows only one memory and only one processor. In an actual terminal device, there may be a plurality of processors and memories. The memory may also be referred to as a storage medium, a storage device, or the like. This is not limited in embodiments of this application.

For example, the processor may include a baseband processor and a central processing unit. The baseband processor is mainly configured to process the communication protocol and the communication data. The central processing unit is mainly configured to: control the entire terminal device, execute the software program, and process the data of the software program. The processor in FIG. 14 integrates functions of the baseband processor and the central processing unit. A person skilled in the art may understand that the baseband processor and the central processing unit may alternatively be separate processors, and are interconnected by using a technology such as a bus. A person skilled in the art may understand that the terminal device may include a plurality of baseband processors to adapt to different network standards, and the terminal device may include a plurality of central processing units to enhance a processing capability of the terminal device, and components of the terminal device may be connected through various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the storage unit in a form of a software program, and the processor executes the software program to implement a baseband processing function.

For example, in this embodiment of this application, the antenna and the control circuit that have receiving and sending functions may be considered as a transceiver unit 810 of the terminal device 800, and the processor that have a processing function may be considered as a processing unit 820 of the terminal device 800. As shown in FIG. 14, the terminal device 800 includes the transceiver unit 810 and the processing unit 820. The transceiver unit may also be referred to as a transceiver, a transceiver machine, a transceiver apparatus, or the like. Optionally, a component that is in the transceiver unit 810 and that is configured to implement a receiving function may be considered as a receiving unit, and a component that is in the transceiver unit 810 and that is configured to implement a sending function may be considered as a sending unit. In other words, the transceiver unit includes a receiving unit and a sending unit. For example, the receiving unit may also be referred to as a receiver, a receiver machine, or a receiver circuit, and the sending unit may also be referred to as a transmitter, a transmitter machine, or a transmitter circuit.

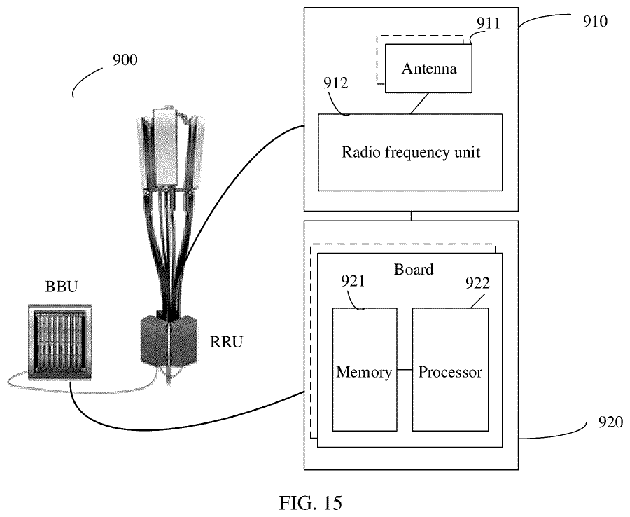

FIG. 15 is a diagram of a structure of an access network device 900 according to an embodiment of this application. The access network device 900 may be configured to implement functions of the access device (for example, a first access network device, a second access network device, or a third access network device) in the foregoing method. The access network device 900 includes one or more radio frequency units such as a remote radio unit (RRU) 910 and one or more baseband units (BBUs) (which may also be referred to as a digital unit (DU)) 920. The RRU 910 may be referred to as a transceiver unit, a transceiver, a transceiver circuit, a transceiver machine, or the like, and may include at least one antenna 911 or a radio frequency unit 912. The RRU 910 part is mainly configured to: send and receive a radio frequency signal, and perform conversion between a radio frequency signal and a baseband signal, for example, is configured to send the signaling messages in the foregoing embodiments to the terminal device. The BBU 920 part is mainly configured to: perform baseband processing, control a base station, and the like. The RRU 910 and the BBU 920 may be physically disposed together, or may be physically disposed separately, that is, a distributed base station.

The BBU 920 is a control center of the base station, may also be referred to as a processing unit, and is mainly configured to complete a baseband processing function such as channel coding, multiplexing, modulation, or spreading. For example, the BBU (the processing unit) 920 may be configured to control a base station 40 to perform an operation procedure related to the access network device in the foregoing method embodiments.

In an example, the BBU 920 may include one or more boards, and a plurality of boards may jointly support a radio access network (for example, an LTE system or a 5G system) of a single access standard, or may separately support radio access networks of different access standards. The BBU 920 further includes a memory 921 and a processor 922. The memory 921 is configured to store necessary instructions and data. For example, the memory 921 stores the codebook and the like in the foregoing embodiments. The processor 922 is configured to control the base station to perform a necessary action, for example, configured to control the base station to perform an operation procedure related to the access network device in the foregoing method embodiments. The memory 921 and the processor 922 may serve one or more boards. In other words, a memory and a processor may be disposed on each board. Alternatively, a plurality of boards may share a same memory and a same processor. In addition, a necessary circuit may be further disposed on each board.

In a possible implementation, with development of a system-on-chip (SoC) technology, all or some functions of the parts 920 and 910 may be implemented by using the SoC technology, for example, implemented by one base station function chip. The base station function chip integrates components such as a processor, a memory, and an antenna port. A program of a base station-related function is stored in the memory, and the processor executes the program to implement the base station-related function. Optionally, the base station function chip can also read from an external memory of the chip, to implement the base station-related function.

It should be understood that the structure of the access network device shown in FIG. 15 is merely a possible form, and should not constitute any limitation on embodiments of this application. In this application, a possibility that there may be a base station structure in another form in the future is not excluded.

It should be understood that, the processor in embodiments of this application may be a central processing unit (CPU), or the processor may be another general purpose processor, a digital signal processor (DSP), an application-specific integrated circuit (ASIC), a field programmable gate array (FPGA), or another programmable logic device, a discrete gate or transistor logic device, a discrete hardware component, or the like. A general-purpose processor may be a microprocessor, or the processor may be any conventional processor or the like.

It should be further understood that the memory in embodiments of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example and not limitation, random access memories (RAMs) in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented by software, hardware, firmware, or any combination thereof. When the software is used to implement embodiments, the foregoing embodiments may be implemented completely or partially in a form of a computer program product. The computer program product includes one or more computer instructions or computer programs. When the computer instructions or the computer programs are loaded and executed on a computer, procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, microwave, or the like) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

An embodiment of this application further provides a computer-readable medium. The computer-readable medium stores a computer program. When the computer program is executed by a computer, the steps performed by the terminal device or the steps performed by the access network device in any one of the foregoing embodiments are implemented.

An embodiment of this application further provides a computer program product. When the computer program product is executed by a computer, the steps performed by the terminal device or the steps performed by the access network device in any one of the foregoing embodiments are implemented.

An embodiment of this application further provides a system chip. The system chip includes a communication unit and a processing unit. The processing unit may be, for example, a processor. The communication unit may be, for example, a communication interface, an input/output interface, a pin, or a circuit. The processing unit may execute computer instructions, so that the chip in the communication apparatus performs the steps performed by the terminal device or the steps performed by the access network device provided in the foregoing embodiments of this application.

Optionally, the computer instructions are stored in a storage unit.

According to the method provided in embodiments of this application, an embodiment of this application further provides a communication system, including the foregoing access network device and terminal device.

Embodiments of this application may be used alone or used in combination. This is not limited herein.

In addition, aspects or features of this application may be implemented as a method, an apparatus, or a product that uses standard programming and/or engineering technologies. The term “product” used in this application covers a computer program that can be accessed from any computer-readable component, carrier, or medium. For example, a computer-readable medium may include but is not limited to: a magnetic storage component (for example, a hard disk, a floppy disk, or a magnetic tape), an optical disc (for example, a compact disc (CD) and a digital versatile disc (DVD)), a smart card, and a flash memory component (for example, an erasable programmable read-only memory (EPROM), a card, a stick, or a key drive). In addition, various storage media described in this specification may represent one or more devices and/or other machine-readable media that are configured to store information. The term “machine-readable media” may include but is not limited to a radio channel, and various other media that can store, include, and/or carry instructions and/or data.

It should be understood that the term “and/or” describes an association relationship for describing associated objects and indicates that any one of three relationships may exist. For example, A and/or B may indicate one of the following three cases: Only A exists, both A and B exist, or only B exists. The character “/” generally indicates an “or” relationship between the associated objects. “At least one” means one or more. “At least one of A and B” is similar to “A and/or B”, is used to describe an association relationship between associated objects, and indicates that there may be one of three relationships. For example, at least one of A or B may indicate one of the following three cases: Only A exists, both A and B exist, and only B exists.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments.

In some embodiments according to this application, it should be understood that the disclosed system, apparatus, and method may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings, direct couplings, or communication connections may be implemented through some interfaces. The indirect couplings or communication connections between the apparatuses or units may be implemented in electrical, mechanical, or another form.

The units described as separate components may or may not be physically separate, and components displayed as units may or may not be physical units, that is, may be located in one position, or may be distributed on a plurality of network units. Some or all of the units may be selected based on actual requirements to achieve the objectives of the solutions in embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, technical solutions of this application essentially, or the part contributing to the current technology, or some of the technical solutions may be implemented in a form of a software product. The computer software product is stored in a storage medium, and includes several instructions for instructing a computer device (which may be a personal computer, a server, an access network device, or the like) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely non-limiting examples of specific implementations, and are not intended to limit the protection scope, which is intended to cover any variation or replacement readily determined by a person of ordinary skill in the art. Therefore, the claims shall define the protection scope.

1. A channel state information (CSI) feedback method performed by a first communication apparatus, comprising:
sending first CSI to a second communication apparatus, wherein the first CSI comprises indication information of a first basis of statistical eigen subspace, and a period for sending the first CSI by the first communication apparatus is a first period;
before updating a second basis to the first basis, sending second CSI to the second communication apparatus, wherein the second CSI comprises indication information of a first linear combination coefficient, a period for sending the second CSI by the first communication apparatus is a second period, the first period is greater than the second period, and the first linear combination coefficient is a combination coefficient corresponding to the second basis, wherein
the second CSI is generated by the first communication apparatus based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain;
updating the second basis to the first basis based on trigger information; and
after updating the second basis to the first basis, sending third channel state information to the second communication apparatus, wherein the third channel state information comprises indication information of a second linear combination coefficient, the third channel state information is generated by the first communication apparatus based on the updated second basis, and a period for sending the third channel state information by the first communication apparatus is the second period.

2. The method according to claim 1, wherein when the trigger information is timing information, the updating the second basis to the first basis based on trigger information comprises:
when the timing information reaches a specified time, updating the second basis to the first basis.

3. The method according to claim 2, wherein the timing information is obtained by the first communication apparatus from the second communication apparatus by using configuration information, or the timing information is predefined.

4. The method according to claim 3, wherein the method further comprises:
receiving update indication information sent by the second communication apparatus, wherein the update indication information indicates the first communication apparatus to update the second basis of the statistical eigen subspace to the first basis; and
the updating the second basis to the first basis based on trigger information comprises:
updating the second basis to the first basis based on the update indication information.

5. The method according to claim 4, wherein before the updating the second basis to the first basis based on trigger information, the method further comprises:
receiving retransmission signaling sent by the second communication apparatus, wherein the retransmission signaling indicates the first communication apparatus to retransmit the first CSI; and
retransmitting the first CSI to the second communication apparatus based on the retransmission signaling.

6. The method according to claim 5, wherein at least one of the update indication information, the configuration information, or the retransmission signaling is comprised in radio resource control (RRC) signaling, media access control-control element (MAC-CE) signaling, or downlink control information (DCI).

7. A first communication apparatus, comprising:
at least one processor, and a memory storing processor-executable instructions that, when executed by the at least one processor, cause the first communication apparatus to perform operations including:
sending first channel state information (CSI) to a second communication apparatus, wherein the first CSI comprises indication information of a first basis of statistical eigen subspace, and a period for sending the first CSI by the first communication apparatus is a first period, wherein
before updating a second basis to the first basis, sending second CSI to the second communication apparatus, wherein the second CSI comprises indication information of a first linear combination coefficient, a period for sending the second CSI by the first communication apparatus is a second period, the first period is greater than the second period, and the first linear combination coefficient is a combination coefficient corresponding to the second basis, wherein
the second CSI is generated by the first communication apparatus based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain; and
updating the second basis to the first basis based on trigger information; and
after updating the second basis to the first basis, sending third CSI to the second communication apparatus, wherein the third CSI comprises indication information of a second linear combination coefficient, the third CSI is generated by the first communication apparatus based on the updated second basis, and a period for sending the third CSI by the first communication apparatus is the second period.

8. The first communication apparatus according to claim 7, wherein the operations further include:
when timing information reaches a specified time, updating the second basis to the first basis.

9. The first communication apparatus according to claim 8, wherein the timing information is obtained by a transceiver from the second communication apparatus by using configuration information, or the timing information is predefined.

10. The first communication apparatus according to claim 9, wherein the operations further include:
receiving update indication information sent by the second communication apparatus, wherein the update indication information indicates the first communication apparatus to update the second basis of the statistical eigen subspace to the first basis; and
updating the second basis to the first basis based on the update indication information.

11. The first communication apparatus according to claim 10, wherein the operations further include:
receiving retransmission signaling sent by the second communication apparatus, wherein the retransmission signaling indicates the first communication apparatus to retransmit the first CSI; and
retransmitting the first CSI to the second communication apparatus based on the retransmission signaling.

12. The first communication apparatus according to claim 11, wherein at least one of the update indication information, the configuration information, or the retransmission signaling is comprised in radio resource control (RRC) signaling, media access control-control element (MAC-CE) signaling, or downlink control information (DCI).

13. A non-transitory computer-readable storage medium storing computer instructions that, when executed by at least one processor, cause the at least one processor to perform operations including:
sending first channel state information (CSI) to a second communication apparatus, wherein the first CSI comprises indication information of a first basis of statistical eigen subspace, and a period for sending the first CSI by a first communication apparatus is a first period, wherein
before updating a second basis to the first basis, sending second CSI to the second communication apparatus, wherein the second CSI comprises indication information of a first linear combination coefficient, a period for sending the second CSI by the first communication apparatus is a second period, the first period is greater than the second period, and the first linear combination coefficient is a combination coefficient corresponding to the second basis, wherein
the second CSI is generated by the first communication apparatus based on the second basis of the statistical eigen subspace, the first basis is different from the second basis, and the first basis and the second basis separately indicate a change rule of a downlink channel in at least one of space domain or frequency domain, or the first basis and the second basis separately indicate a change rule of a downlink channel in joint space-frequency domain; and
updating the second basis to the first basis based on trigger information; and
after updating the second basis to the first basis, sending third CSI to the second communication apparatus, wherein the third CSI comprises indication information of a second linear combination coefficient, the third CSI is generated by the first communication apparatus based on the updated second basis, and a period for sending the third CSI by the first communication apparatus is the second period.

14. The non-transitory computer-readable storage medium according to claim 13, wherein the operations further include:
when timing information reaches a specified time, updating the second basis to the first basis.

15. The non-transitory computer-readable storage medium according to claim 14, wherein the timing information is obtained by a transceiver from the second communication apparatus by using configuration information, or the timing information is predefined.

16. The non-transitory computer-readable storage medium according to claim 15, wherein the operations further include:
receiving update indication information sent by the second communication apparatus, wherein the update indication information indicates the first communication apparatus to update the second basis of the statistical eigen subspace to the first basis; and
updating the second basis to the first basis based on the update indication information.

17. The non-transitory computer-readable storage medium according to claim 16, wherein the operations further include:
receiving retransmission signaling sent by the second communication apparatus, wherein the retransmission signaling indicates the first communication apparatus to retransmit the first CSI; and
retransmitting the first CSI to the second communication apparatus based on the retransmission signaling.

18. The non-transitory computer-readable storage medium according to claim 17, wherein at least one of the update indication information, the configuration information, or the retransmission signaling is comprised in radio resource control (RRC) signaling, media access control-control element (MAC-CE) signaling, or downlink control information (DCI).
